(19) United States
(12) Patent Application Publication
(10) Pub. No.: US 2023/0284039 A1
(43) Pub. Date: Sep. 7, 2023

(54) METHOD AND APPARATUS FOR MULTIPLE BEAMS COLLISION HANDLING IN A WIRELESS COMMUNICATION SYSTEM

(71) Applicant: ASUSTek Computer Inc., Taipei City 112 (TW)

(72) Inventor: Ko-Chiang Lin, Taipei City (TW)

(21) Appl. No.: 18/117,261

(22) Filed: Mar. 3, 2023

Related U.S. Application Data
(60) Provisional application No. 63/316,813, filed on Mar. 4, 2022.
(60) Provisional application No. 63/316,821, filed on Mar. 4, 2022.

(51) Int. Cl. H04W 16/28; H04W 72/0453; H04B 7/06

(52) U.S. Cl. CPC H04W 16/28; H04W 72/0453; H04B 7/0695

(57) ABSTRACT

Methods, systems, and apparatuses for multiple beam collision handling in a wireless communication system. A method for a User Equipment (UE) in a wireless communication system can comprise receiving indication of one or more first frequency resources associated with Uplink (UL) for a first beam and/or a first set of beams from a base station, determining whether to perform or cancel a first UL transmission based on the one or more first frequency resources when the first UL transmission is associated with the first beam and/or the first set of beams, and not determining whether to perform or cancel a second UL transmission based on the one or more first frequency resources when the second UL transmission is associated with a second beam and/or a second set of beams.

### CROSS-REFERENCE TO RELATED APPLICATIONS

The present application claims priority to and the benefit of U.S. Provisional Patent Application Ser. No. 63/316,813, filed Mar. 4, 2022, and U.S. Provisional Patent Application Ser. No. 63/316,821, filed Mar. 4, 2022; with each of the referenced applications and disclosures fully incorporated herein by reference.

### FIELD

This disclosure generally relates to wireless communication networks and, more particularly, to a method and apparatus for multiple beams collision handling in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for multiple beam collision handling in a wireless communication system such that slot format for duplexing enhancement is more efficient, slot format on multiple beams for duplexing enhancement is more efficient, and collision handling among multiple beams for duplexing enhancement is more efficient.

In various embodiments of the present invention, a method for a User Equipment (UE) in a wireless communication system comprises receiving indication of one or more first frequency resources associated with Uplink (UL) for a first beam and/or a first set of beams from a base station, determining whether to perform or cancel a first UL transmission based on the one or more first frequency resources when the first UL transmission is associated with the first beam and/or the first set of beams, and not determining whether to perform or cancel a second UL transmission based on the one or more first frequency resources when the second UL transmission is associated with a second beam and/or a second set of beams.

In various embodiments of the present invention, a method for a UE in a wireless communication system comprises receiving a first indication of one or more first frequency resources associated with UL for a first beam and/or a first set of beams from a base station, receiving a second indication of one or more second frequency resources associated with UL for a second beam and/or a second set of beams from a base station, determining whether to perform or cancel a first UL transmission based on the one or more first frequency resources when the first UL transmission is associated with the first beam and/or the first set of beams, and determining whether to perform or cancel a second UL transmission based on the one or more second frequency resources when the second UL transmission is associated with a second beam and/or a second set of beams.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a flow diagram of a UE handling reception/transmission based on a third SFI, in accordance with embodiments of the present invention.

FIG. 6 is a flow diagram of a UE performing first and second actions related to collision handling, in accordance with embodiments of the present invention.

FIG. 7 is a flow diagram of a UE determining whether to perform or cancel first and second UL transmissions based on first frequency resources, in accordance with embodiments of the present invention.

FIG. 8 is a flow diagram of a UE determining whether to perform or cancel first and second UL transmissions based on first and second frequency resources, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.211 V15.7.0, “NR physical channels and modulation”; [2] 3GPP TS 38.213 V16.6.0, “NR Physical layer procedures for control”; [3] RP-212707, “Draft SID on Evolution of NR Duplex Operation”; and [4] 3GPP TS 38.214 V17.0.0, “NR Physical layer procedures for data”. The standards and documents listed above are hereby expressly and fully incorporated herein by reference in their entirety.

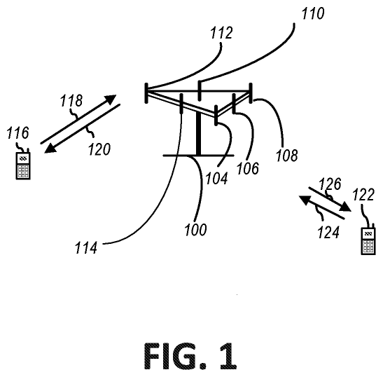

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

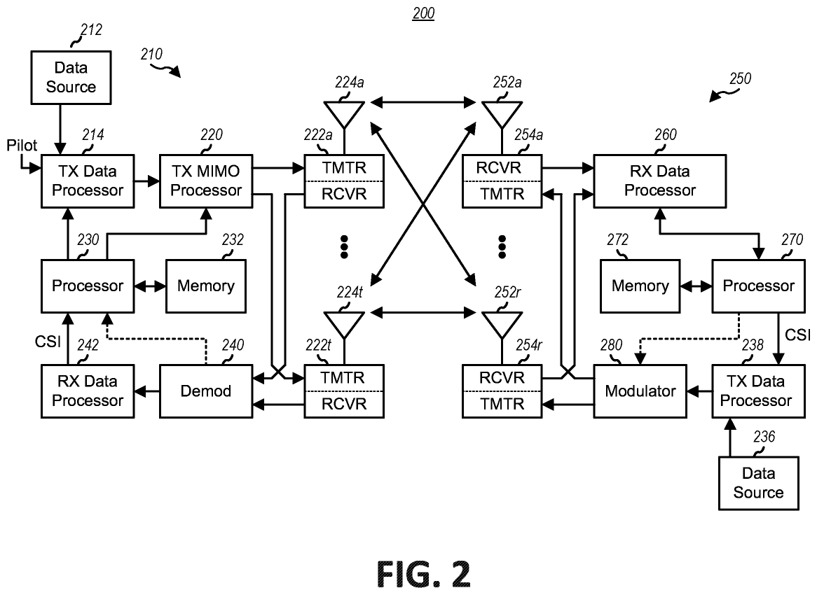

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

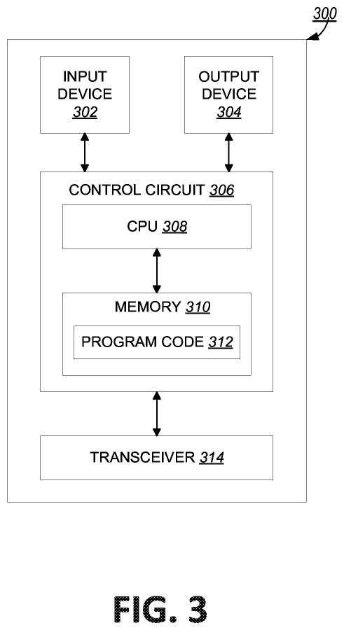

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

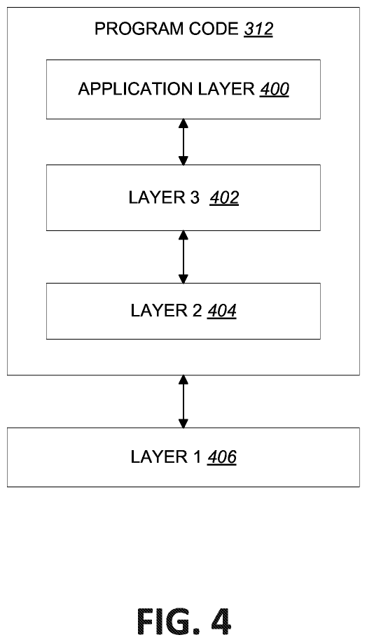

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

More details of NR frame structure, channel and numerology design is given below from [1] 3GPP TS 38.211 V15.7.0, “NR physical channels and modulation”.

### Quotation Start

### 4.3 Frame Structure

### 4.3.2 Slots

For subcarrier spacing configuration μ, slots are numbered nₛ^{μ}∈{0, . . . , Nₛₗₒₜ^{subframe,μ}−1} in increasing order within a subframe and n_{s,f}^{μ}∈{0, . . . , Nₛₗₒₜ^{frame,μ}−1} in increasing order within a frame. There are N_{symb}^{slot} consecutive OFDM symbols in a slot where N_{symb}^{slot} depends on the cyclic prefix as given by Tables 4.3.2-1 and 4.3.2-2. The start of slot nₛ^{μ} in a subframe is aligned in time with the start of OFDM symbol nₛ^{μ} N_{symb}^{slot} in the same subframe.
OFDM symbols in a slot can be classified as ‘downlink’, ‘flexible’, or ‘uplink’. Signaling of slot formats is described in subclause 11.1 of [5, TS 38.213].
In a slot in a downlink frame, the UE shall assume that downlink transmissions only occur in ‘downlink’ or ‘flexible’ symbols.
In a slot in an uplink frame, the UE shall only transmit in ‘uplink’ or ‘flexible’ symbols.
A UE not capable of full-duplex communication and not supporting simultaneous transmission and reception as defined by parameter simultaneousRxTxInterBandENDC, simultaneousRxTxInterBandCA or simultaneousRxTxSUL [10, TS 38.306] among all cells within a group of cells is not expected to transmit in the uplink in one cell within the group of cells earlier than N_{Rx-Tx}T_{c} after the end of the last received downlink symbol in the same or different cell within the group of cells where N_{Rx-Tx} is given by Table 4.3.2-3.
A UE not capable of full-duplex communication and not supporting simultaneous transmission and reception as defined by parameter simultaneousRxTxInterBandENDC, simultaneousRxTxInterBandCA or simultaneousRxTxSUL [10, TS 38.306] among all cells within a group of cells is not expected to receive in the downlink in one cell within the group of cells earlier than N_{Tx-Rx}T_{c} after the end of the last transmitted uplink symbol in the same or different cell within the group of cells where N_{Tx-Rx} is given by Table 4.3.2-3.
A UE not capable of full-duplex communication is not expected to transmit in the uplink earlier than N_{Rx-Tx}T_{c} after the end of the last received downlink symbol in the same cell where N_{Rx-Tx} is given by Table 4.3.2-3.
A UE not capable of full-duplex communication is not expected to receive in the downlink earlier than N_{Tx-Rx}T_{c} after the end of the last transmitted uplink symbol in the same cell where N_{Tx-Rx} is given by Table 4.3.2-3.

### 4.4.4 Resource Blocks

A resource block is defined as N_{sc}^{RB}=12 consecutive subcarriers in the frequency domain.

### 4.4.4.4 Physical Resource Blocks

Physical resource blocks for subcarrier configuration μ are defined within a bandwidth part and numbered from 0 to N_{BWP,i}^{size,μ}−1 where i is the number of the bandwidth part. The relation between the physical resource block n_{PRB}^{μ} in bandwidth part i and the common resource block n_{CRB}^{μ} is given by

n_{CRB}^{μ}=n_{PRB}^{μ}+N_{BWP,i}^{start,μ}

where N_{BWP,i}^{start,μ} is the common resource block where bandwidth part starts relative to common resource block 0. When there is no risk for confusion the index it may be dropped.

### Quotation End

Slot format information (SFI) is introduced to indicate transmission direction for a symbol(s), e.g., Downlink (DL), Uplink (UL) or Flexible. SFI could be indicated or revealed by several signals, such as Radio Resource Control (RRC) configuration, Downlink Control Information (DCI) for SFI, scheduling DCI. Some handling would be then required if more than one direction is indicated to a symbol. More details regarding SFI is quoted below from [2] 3GPP TS 38.213 V16.6.0, “NR Physical layer procedures for control”:

### Quotation Start

### 11.1 Slot Configuration

A slot format includes downlink symbols, uplink symbols, and flexible symbols.
The following are applicable for each serving cell.
If a UE is provided tdd-UL-DL-ConfigurationCommon, the UE sets the slot format per slot over a number of slots as
If the UE is additionally provided tdd-UL-DL-ConfigurationDedicated, the parameter tdd-UL-DL-ConfigurationDedicated overrides only flexible symbols per slot over the number of slots as provided by tdd-UL-DL-ConfigurationCommon.
For each slot having a corresponding index provided by slotIndex, the UE applies a format provided by a corresponding symbols. The UE does not expect tdd-UL-DL-ConfigurationDedicated to indicate as uplink or as downlink a symbol that tdd-UL-DL-ConfigurationCommon indicates as a downlink or as an uplink symbol, respectively.
For each slot configuration provided by tdd-UL-DL-ConfigurationDedicated, a reference SCS configuration is the reference SCS configuration μ_{ref} provided by tdd-UL-DL-ConfigurationCommon.
A slot configuration period and a number of downlink symbols, uplink symbols, and flexible symbols in each slot of the slot configuration period are determined from tdd-UL-DL-ConfigurationCommon and tdd-UL-DL-ConfigurationDedicated and are common to each configured BWP.
A UE considers symbols in a slot indicated as downlink by tdd-UL-DL-ConfigurationCommon, or tdd-UL-DL-ConfigurationDedicated to be available for receptions and considers symbols in a slot indicated as uplink by tdd-UL-DL-ConfigurationCommon, or by tdd-UL-DL-ConfigurationDedicated to be available for transmissions.
If a UE is not configured to monitor PDCCH for DCI format 2_0, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE
the UE receives PDSCH or CSI-RS in the set of symbols of the slot if the UE receives a corresponding indication by a DCI format
the UE transmits PUSCH, PUCCH, PRACH, or SRS in the set of symbols of the slot if the UE receives a corresponding indication by a DCI format, a RAR UL grant, fallbackRAR UL grant, or successRAR
   For operation on a single carrier in unpaired spectrum, if a UE is configured by higher layers to receive a PDCCH, or a PDSCH, or a CSI-RS, or a DL PRS in a set of symbols of a slot, the UE receives the PDCCH, the PDSCH, the CSI-RS, or the DL PRS if the UE does not detect a DCI format that indicates to the UE to transmit a PUSCH, a PUCCH, a PRACH, or a SRS in at least one symbol of the set of symbols of the slot; otherwise, the UE does not receive the PDCCH, or the PDSCH, or the CSI-RS, or the DL PRS in the set of symbols of the slot.
   For operation on a single carrier in unpaired spectrum, if a UE is configured by higher layers to transmit SRS, or PUCCH, or PUSCH, or PRACH in a set of symbols of a slot and the UE detects a DCI format indicating to the UE to receive CSI-RS or PDSCH in a subset of symbols from the set of symbols, then
If the UE does not indicate the capability of [partialCancellation], the UE does not expect to cancel the transmission of the PUCCH or PUSCH or PRACH in the set of symbols if the first symbol in the set occurs within T_{proc,2} relative to a last symbol of a CORESET where the UE detects the DCI format; otherwise, the UE cancels the PUCCH, or the PUSCH, or an actual repetition of the PUSCH [6, TS38.214], determined from clauses 9 and 9.2.5 or clause 6.1 of [6, TS38.214], or the PRACH transmission in the set of symbols.
If the UE indicates the capability of [partialCancellation], the UE does not expect to cancel the transmission of the PUCCH or PUSCH or PRACH in symbols from the set of symbols that occur within T_{proc,2} relative to a last symbol of a CORESET where the UE detects the DCI format. The UE cancels the PUCCH, or the PUSCH, or an actual repetition of the PUSCH [6, TS 38.214], determined from clauses 9 and 9.2.5 or clause 6.1 of [6, TS 38.214], or the PRACH transmission in remaining symbols from the set of symbols.
The UE does not expect to cancel the transmission of SRS in symbols from the subset of symbols that occur within T_{proc,2} relative to a last symbol of a CORESET where the UE detects the DCI format. The UE cancels the SRS transmission in remaining symbols from the subset of symbols.
T_{proc,2} is the PUSCH preparation time for the corresponding UE processing capability [6, TS 38.214] assuming d_{2,1}=1 and μ corresponds to the smallest SCS configuration between the SCS configuration of the PDCCH carrying the DCI format and the SCS configuration of the SRS, PUCCH, PUSCH or μᵣ, where μᵣ corresponds to the SCS configuration of the PRACH if it is 15 kHz or higher; otherwise μᵣ=0.
   For a set of symbols of a slot that are indicated to a UE as uplink by tdd-UL-DL-ConfigurationCommon, or tdd-UL-DL-ConfigurationDedicated, the UE does not receive PDCCH, PDSCH, or CSI-RS when the PDCCH, PDSCH, or CSI-RS overlaps, even partially, with the set of symbols of the slot.
   For a set of symbols of a slot that are indicated to a UE as uplink by tdd-UL-DL-ConfigurationCommon, or tdd-UL-DL-ConfigurationDedicated, the UE does not receive DL PRS in the set of symbols of the slot, if the UE is not provided with a measurement gap.
   For a set of symbols of a slot that are indicated to a UE as downlink by tdd-UL-DL-ConfigurationCommon, or tdd-UL-DL-ConfigurationDedicated, the UE does not transmit PUSCH, PUCCH, PRACH, or SRS when the PUSCH, PUCCH, PRACH, or SRS overlaps, even partially, with the set of symbols of the slot.
   For a set of symbols of a slot that are indicated to a UE as flexible by tdd-UL-DL-ConfigurationCommon, and tdd-UL-DL-ConfigurationDedicated if provided, the UE does not expect to receive both dedicated higher layer parameters configuring transmission from the UE in the set of symbols of the slot and dedicated higher layer parameters configuring reception by the UE in the set of symbols of the slot.
   For operation on a single carrier in unpaired spectrum, for a set of symbols of a slot indicated to a UE by ssb-PositionsInBurst in SIB1 or ssb-PositionsInBurst in ServingCellConfigCommon, for reception of SS/PBCH blocks, the UE does not transmit PUSCH, PUCCH, PRACH in the slot if a transmission would overlap with any symbol from the set of symbols and the UE does not transmit SRS in the set of symbols of the slot. The UE does not expect the set of symbols of the slot to be indicated as uplink by tdd-UL-DL-ConfigurationCommon, or tdd-UL-DL-ConfigurationDedicated, when provided to the UE.
   For a set of symbols of a slot corresponding to a valid PRACH occasion and N_{gap} symbols before the valid PRACH occasion, as described in clause 8.1, the UE does not receive PDCCH, PDSCH, or CSI-RS in the slot if a reception would overlap with any symbol from the set of symbols. The UE does not expect the set of symbols of the slot to be indicated as downlink by tdd-UL-DL-ConfigurationCommon or tdd-UL-DL-ConfigurationDedicated.
   For a set of symbols of a slot indicated to a UE by pdcch-ConfigSIB1 in MIB for a CORESET for Type0-PDCCH CSS set, the UE does not expect the set of symbols to be indicated as uplink by tdd-UL-DL-ConfigurationCommon, or tdd-UL-DL-ConfigurationDedicated.
   If a UE is scheduled by a DCI format to receive PDSCH over multiple slots, and if tdd-UL-DL-ConfigurationCommon, or tdd-UL-DL-ConfigurationDedicated, indicate that, for a slot from the multiple slots, at least one symbol from a set of symbols where the UE is scheduled PDSCH reception in the slot is an uplink symbol, the UE does not receive the PDSCH in the slot.
   If a UE is scheduled by a DCI format to transmit PUSCH over multiple slots, and if tdd-UL-DL-ConfigurationCommon, or tdd-UL-DL-ConfigurationDedicated, indicates that, for a slot from the multiple slots, at least one symbol from a set of symbols where the UE is scheduled PUSCH transmission in the slot is a downlink symbol, the UE does not transmit the PUSCH in the slot.

### 11.1.1 UE Procedure for Determining Slot Format

If a UE is configured by higher layers with parameter SlotFormatIndicator, the UE is provided an SFI-RNTI by sfi-RNTI and with a payload size of DCI format 2_0 by dci-PayloadSize.
A SFI-index field value in a DCI format 2_0 indicates to a UE a slot format for each slot in a number of slots for each DL BWP or each UL BWP starting from a slot where the UE detects the DCI format 2_0. The number of slots is equal to or larger than a PDCCH monitoring periodicity for DCI format 2_0. The SFI-index field includes max{┌log₂(maxSFIindex+1)┐,1} bits where maxSFIndex is the maximum value of the values provided by corresponding slotFormatCombinationId. A slot format is identified by a corresponding format index as provided in Table 11.1.1-1 where denotes a downlink symbol, ‘U’ denotes an uplink symbol, and ‘F’ denotes a flexible symbol.
If a PDCCH monitoring periodicity for DCI format 2_0, provided to a UE for the search space set S by monitoringSlotPeriodicityAndOffset, is smaller than a duration of a slot format combination the UE obtains at a PDCCH monitoring occasion for DCI format 2_0 by a corresponding SFI-index field value, and the UE detects more than one DCI formats 2_0 indicating a slot format for a slot, the UE expects each of the more than one DCI formats 2_0 to indicate a same format for the slot.

TABLE 11.1.1-1
Slot formats for normal cyclic prefix

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |

. . .

| | | | | | | | | | | | | | | |
|---|---|---|---|---|---|---|---|---|---|---|---|---|---|---|
| 55 | D | D | F | F | F | U | U | U | D | D | D | D | D | D |

| | |
|---|---|
| 56-254 | Reserved |
| 255 | UE determines the slot format for the slot based on |
| | tdd-UL-DL-ConfigurationCommon, or tdd-UL-DL- |
| | ConfigurationDedicated and, if any, on detected DCI formats |

For unpaired spectrum operation for a UE on a serving cell, the UE is provided by subcarrierSpacing a reference SCS configuration μ_{SFI} for each slot format in a combination of slot formats indicated by an SFI-index field value in DCI format 2_0. The UE expects that for a reference SCS configuration μ_{SFI} and for an active DL BWP or an active UL BWP with SCS configuration μ, it is μ≥μ_{SFI}. Each slot format in the combination of slot formats indicated by the SFI-index field value in DCI format 2_0 is applicable to 2^{(μ-μ}^{_{SFI}}⁾ consecutive slots in the active DL BWP or the active UL BWP where the first slot starts at a same time as a first slot for the reference SCS configuration μ_{SFI} and each downlink or flexible or uplink symbol for the reference SCS configuration μ_{SFI} corresponds to 2^{(μ-μ}^{_{SFI}}⁾ consecutive downlink or flexible or uplink symbols for the SCS configuration μ.

For unpaired spectrum operation with a second UL carrier for a UE on a serving cell, the SFI-index field value in DCI format 2_0 indicates a combination of slot formats that includes a combination of slot formats for a reference first UL carrier of the serving cell and a combination of slot formats for a reference second UL carrier of the serving cell. The UE is provided by subcarrierSpacing a reference SCS configuration μ_{SFI} for the combination of slot formats indicated by the SFI-index field in DCI format 2_0 for the reference first UL carrier of the serving cell. The UE is provided by subcarrierSpacing2 a reference SCS configuration μ_{SFI,SUL} for the combination of slot formats indicated by the SFI-index field value in DCI format 2_0 for the reference second UL carrier of the serving cell. For each 2^{(μ}^{_{SFI}}^{-μ}^{_{SFI,SUL}}⁾+1 values of slotFormats, the first 2^{(μ}^{_{SFI}}^{-μ}^{_{SFI,SUL}}⁾ values for the combination of slot formats are applicable to the reference first UL carrier and the next value is applicable to the reference second UL carrier.

The UE expects to be provided a reference SCS configuration μ_{SFI,SUL} so that for an active UL BWP in the second UL carrier with SCS configuration μ_{SUL}, it is μ_{SUL}≥μ_{SFI,SUL}. Each slot format for a combination of slot formats indicated by the SFI-index field in DCI format 2_0 for the reference first UL carrier is applicable to 2^{(μ-μ}^{_{SFI}}⁾ consecutive slots for the active DL BWP and the active UL BWP in the first UL carrier where the first slot starts at a same time as a first slot in the reference first UL carrier. Each slot format for the combination of slot formats for the reference second UL carrier is applicable to 2^{(μ}^{_{SUL}}^{-μ}^{_{SFI,SUL}}⁾ consecutive slots for the active UL BWP in the second UL carrier where the first slot starts at a same time as a first slot in the reference second UL carrier.
For a set of symbols of a slot, a UE does not expect to detect a DCI format 2_0 with an SFI-index field value indicating the set of symbols of the slot as uplink and to detect a DCI format indicating to the UE to receive PDSCH or CSI-RS in the set of symbols of the slot.
For a set of symbols of a slot, a UE does not expect to detect a DCI format 2_0 with an SFI-index field value indicating the set of symbols in the slot as downlink and to detect a DCI format, a RAR UL grant, fallbackRAR UL grant, or successRAR indicating to the UE to transmit PUSCH, PUCCH, PRACH, or SRS in the set of symbols of the slot.
For a set of symbols of a slot that are indicated by a DCI format 2_0 as being within a remaining channel occupancy duration either by a channel occupancy duration field or by an SFI-index field, a UE does not expect to detect at a later time a DCI format 2_0 indicating, either by a channel occupancy duration field or by an SFI-index field, that any symbol from the set of symbols is not within a remaining channel occupancy duration.
For a set of symbols of a slot that are indicated as downlink/uplink by tdd-UL-DL-ConfigurationCommon, or tdd-UL-DL-ConfigurationDedicated, the UE does not expect to detect a DCI format 2_0 with an SFI-index field value indicating the set of symbols of the slot as uplink/downlink, respectively, or as flexible.
For a set of symbols of a slot corresponding to SS/PBCH blocks with candidate SS/PBCH block indices corresponding to the SS/PBCH block indexes indicated to a UE by ssb-PositionsInBurst in SIB1, or by ssb-PositionsInBurst in ServingCellConfigCommon, as described in clause 4.1, the UE does not expect to detect a DCI format 2_0 with an SFI-index field value indicating the set of symbols of the slot as uplink.
For a set of symbols of a slot corresponding to a valid PRACH occasion and N_{gap} symbols before the valid PRACH occasion, as described in clause 8.1, the UE does not expect to detect a DCI format 2_0 with an SFI-index field value indicating the set of symbols of the slot as downlink.
For a set of symbols of a slot indicated to a UE by pdcch-ConfigSIB1 in MIB for a CORESET for Type0-PDCCH CSS set, the UE does not expect to detect a DCI format 2_0 with an SFI-index field value indicating the set of symbols of the slot as uplink.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255
if one or more symbols from the set of symbols are symbols in a CORESET configured to the UE for PDCCH monitoring, the UE receives PDCCH in the CORESET only if an SFI-index field value in DCI format 2_0 indicates that the one or more symbols are downlink symbols
if an SFI-index field value in DCI format 2_0 indicates the set of symbols of the slot as flexible and the UE detects a DCI format indicating to the UE to receive PDSCH or CSI-RS in the set of symbols of the slot, the UE receives PDSCH or CSI-RS in the set of symbols of the slot
if an SFI-index field value in DCI format 2_0 indicates the set of symbols of the slot as flexible and the UE detects a DCI format, a RAR UL grant, fallbackRAR UL grant, or successRAR indicating to the UE to transmit PUSCH, PUCCH, PRACH, or SRS in the set of symbols of the slot the UE transmits the PUSCH, PUCCH, PRACH, or SRS in the set of symbols of the slot
if an SFI-index field value in DCI format 2_0 indicates the set of symbols of the slot as flexible, and the UE does not detect a DCI format indicating to the UE to receive PDSCH or CSI-RS, or the UE does not detect a DCI format, a RAR UL, fallbackRAR UL grant, or successRAR grant indicating to the UE to transmit PUSCH, PUCCH, PRACH, or SRS in the set of symbols of the slot, the UE does not transmit or receive in the set of symbols of the slot
if the UE is configured by higher layers to receive PDSCH or CSI-RS in the set of symbols of the slot, the UE receives the PDSCH or the CSI-RS in the set of symbols of the slot only if an SFI-index field value in DCI format 2_0 indicates the set of symbols of the slot as downlink and, if applicable, the set of symbols is within remaining channel occupancy duration
if the UE is configured by higher layers to receive DL PRS in the set of symbols of the slot, the UE receives the DL PRS in the set of symbols of the slot only if an SFI-index field value in DCI format 2_0 indicates the set of symbols of the slot as downlink or flexible.
if the UE is configured by higher layers to transmit PUCCH, or PUSCH, or PRACH in the set of symbols of the slot, the UE transmits the PUCCH, or the PUSCH, or the PRACH in the slot only if an SFI-index field value in DCI format 2_0 indicates the set of symbols of the slot as uplink
if the UE is configured by higher layers to transmit SRS in the set of symbols of the slot, the UE transmits the SRS only in a subset of symbols from the set of symbols of the slot indicated as uplink symbols by an SFI-index field value in DCI format 2_0
a UE does not expect to detect an SFI-index field value in DCI format 2_0 indicating the set of symbols of the slot as downlink and also detect a DCI format, a RAR UL grant, fallbackRAR UL grant, or successRAR indicating to the UE to transmit SRS, PUSCH, PUCCH, or PRACH, in one or more symbols from the set of symbols of the slot
a UE does not expect to detect an SFI-index field value in DCI format 2_0 indicating the set of symbols of the slot as downlink or flexible if the set of symbols of the slot includes symbols corresponding to any repetition of a PUSCH transmission activated by an UL Type 2 grant PDCCH as described in clause 10.2
a UE does not expect to detect an SFI-index field value in DCI format 2_0 indicating the set of symbols of the slot as uplink and also detect a DCI format indicating to the UE to receive PDSCH or CSI-RS in one or more symbols from the set of symbols of the slot
   If a UE is configured by higher layers to receive a CSI-RS or a PDSCH in a set of symbols of a slot and the UE detects a DCI format 2_0 with a slot format value other than 255 that indicates a slot format with a subset of symbols from the set of symbols as uplink or flexible, or the UE detects a DCI format indicating to the UE to transmit PUSCH, PUCCH, SRS, or PRACH in at least one symbol in the set of the symbols, the UE cancels the CSI-RS reception in the set of symbols of the slot or cancels the PDSCH reception in the slot.
   If a UE is configured by higher layers to receive a DL PRS in a set of symbols of a slot and the UE detects a DCI format 2_0 with a slot format value other than 255 that indicates a slot format with a subset of symbols from the set of symbols as uplink, or the UE detects a DCI format indicating to the UE to transmit PUSCH, PUCCH, SRS, or PRACH in at least one symbol in the set of the symbols, the UE cancels the DL PRS reception in the set of symbols of the slot.
   If a UE is configured by higher layers to transmit SRS, or PUCCH, or PUSCH, or PRACH in a set of symbols of a slot and the UE detects a DCI format 2_0 with a slot format value other than 255 that indicates a slot format with a subset of symbols from the set of symbols as downlink or flexible, or the UE detects a DCI format indicating to the UE to receive CSI-RS or PDSCH in a subset of symbols from the set of symbols, then
If the UE does not indicate the capability of [partialCancellation], the UE does not expect to cancel the transmission of the PUCCH or PUSCH or PRACH in the set of symbols if the first symbol in the set occurs within T_{proc,2} relative to a last symbol of a CORESET where the UE detects the DCI format; otherwise, the UE cancels the PUCCH, or the PUSCH, or an actual repetition of the PUSCH [6, TS38.214], determined from clauses 9 and 9.2.5 or clause 6.1 of [6, TS38.214], or the PRACH transmission in the set of symbols.
If the UE indicates the capability of [partialCancellation], the UE does not expect to cancel the transmission of the PUCCH or PUSCH or PRACH in symbols from the set of symbols that occur within T_{proc,2} relative to a last symbol of a CORESET where the UE detects the DCI format. The UE cancels the PUCCH, or the PUSCH, or an actual repetition of the PUSCH [6, TS 38.214], determined from clauses 9 and 9.2.5 or clause 6.1 of [6, TS 38.214], or the PRACH transmission in remaining symbols from the set of symbols.
The UE does not expect to cancel the transmission of SRS in symbols from the subset of symbols that occur within T_{proc,2} relative to a last symbol of a CORESET where the UE detects the DCI format. The UE cancels the SRS transmission in remaining symbols from the subset of symbols.
T_{proc,2} is the PUSCH preparation time for the corresponding UE processing capability [6, TS 38.214] assuming d_{2,1}=1 and μ corresponds to the smallest SCS configuration between the SCS configuration of the PDCCH carrying the DCI format and the SCS configuration of the SRS, PUCCH, PUSCH or μᵣ, where μᵣ corresponds to the SCS configuration of the PRACH if it is 15 kHz or higher; otherwise μᵣ=0.
   A UE assumes that flexible symbols in a CORESET configured to the UE for PDCCH monitoring are downlink symbols if the UE does not detect an SFI-index field value in DCI format 2_0 indicating the set of symbols of the slot as flexible or uplink and the UE does not detect a DCI format indicating to the UE to transmit SRS, PUSCH, PUCCH, or PRACH in the set of symbols.
   For a set of symbols of a slot that are indicated as flexible by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot
the UE receives PDSCH or CSI-RS in the set of symbols of the slot if the UE receives a corresponding indication by a DCI format
the UE transmits PUSCH, PUCCH, PRACH, or SRS in the set of symbols of the slot if the UE receives a corresponding indication by a DCI format, a RAR UL grant, fallbackRAR UL grant, or successRAR
the UE receives PDCCH as described in clause 10.1
if the UE is configured by higher layers to receive PDSCH in the set of symbols of the slot, the UE does not receive the PDSCH in the set of symbols of the slot
if the UE is configured by higher layers to receive CSI-RS in the set of symbols of the slot, the UE does not receive the CSI-RS in the set of symbols of the slot, except when UE is provided CO-DurationsPerCell and the set of symbols of the slot are within the remaining channel occupancy duration.
if the UE is configured by higher layers to receive DL PRS in the set of symbols of the slot, the UE receives the DL PRS
if the UE is configured by higher layers to transmit SRS, or PUCCH, or PUSCH, or PRACH in the set of symbols of the slot and the UE is not provided enableConfiguredUL, then
   if the UE does not indicate the capability of [partialCancellation], the UE does not expect to cancel the transmission of the PUCCH, or the PUSCH, or an actual repetition of the PUSCH [6, TS 38.214], as determined in clauses 9 and 9.2.5 or in clause 6.1 of [6. TS 38.214], or the PRACH in the slot if the first symbol of the PUCCH or the PUSCH or actual repetition of the PUSCH or the PRACH in the slot occurs within T_{proc,2} relative to a last symbol of a CORESET where the UE is configured to monitor PDCCH for DCI format 2_0; otherwise, the UE cancels the PUCCH, or the PUSCH, or an actual repetition of the PUSCH [6, TS 38.214], as determined in clauses 9 and 9.2.5 or in clause 6.1 of [6. TS 38.214], or the PRACH in the slot;
   if the UE indicates the capability of [partialCancellation], the UE does not expect to cancel the transmission of the PUCCH, or the PUSCH, or an actual repetition of the PUSCH [6, TS 38.214], as determined in clauses 9 and 9.2.5 or in clause 6.1 of [6. TS 38.214], or the PRACH in symbols from the set of symbols that occur within T_{proc,2} relative to a last symbol of a CORESET where the UE is configured to monitor PDCCH for DCI format 2_0. The UE cancels the PUCCH, or the PUSCH, or an actual repetition of the PUSCH [6, TS 38.214], as determined in clauses 9 and 9.2.5 or in clause 6.1 of [6. TS 38.214], or the PRACH transmission in remaining symbols from the set of symbols;
   the UE does not expect to cancel the transmission of SRS in symbols from the set of symbols that occur within T_{proc,2} relative to a last symbol of a CORESET where the UE is configured to monitor PDCCH for DCI format 2_0. The UE cancels the SRS transmission in remaining symbols from the set of symbols;
   T_{proc,2} is the PUSCH preparation time for the corresponding UE processing capability [6, TS 38.214] assuming d_{2,1}=1 and μ corresponds to the smallest SCS configuration between the SCS configuration of the PDCCH carrying the DCI format 2_0 and the SCS configuration of the SRS, PUCCH, PUSCH or μᵣ, where μᵣ corresponds to the SCS configuration of the PRACH if it is 15 kHz or higher; otherwise μᵣ=0;
if the UE is configured by higher layers to transmit SRS, or PUCCH, or PUSCH, or PRACH in the set of symbols of the slot and the UE is provided enableConfiguredUL, the UE can transmit the SRS, or PUCCH, or PUSCH, or PRACH, respectively.
   For unpaired spectrum operation for a UE on a cell in a frequency band of FR1, and when the scheduling restrictions due to RRM measurements [10, TS 38.133] are not applicable, if the UE detects a DCI format indicating to the UE to transmit in a set of symbols, the UE is not required to perform RRM measurements [10, TS 38.133] based on a SS/PBCH block or CSI-RS reception on a different cell in the frequency band if the SS/PBCH block or CSI-RS reception includes at least one symbol from the set of symbols.

### Quotation End

(Narrow) beam is introduced to overcome/compensate large propagation loss on a high frequency band. By concentrating the transmission power on a specific direction, e.g., targeting a receiver, the received signal quality, e.g., at the receiver, could be improved to maintain or increase the throughput/data rate under the large loss. Both or either transmission or reception could be performed with a narrow beam. For example, DL transmission could be performed with Tx beam of a base station. A User Equipment (UE) could receive the DL transmission with Rx beam of the UE, e.g., corresponding to or associated with the Tx beam. A proper correspondence or association between DL Transmitter (Tx) beam and DL Receiver (Rx) beam could be maintained by UE and/or gNB. This is also known as a beam pair. Transmission Configuration Indication (TCI) state and/or Quasi-Colocation (QCL) assumption could be used to identify such beam relationship, e.g., to indicates a DL Tx beam or DL Rx beam. One TCI states could be associated with one DL Reference Signal (RS), e.g., a Synchronization Signal Block (SSB) (e.g., Synchronization Signal/Physical Broadcast Channel (SS/PBCH)) or Channel State Information Reference Signal (CSI-RS). The DL RS could be transmitted with a base station beam. gNB could indicates a DL transmission is transmitted with a TCI state (e.g., with QCL type D). The UE could realize the DL transmission is performed with a base station beam (e.g., DL Tx beam) which is the same as base station beam used for DL RS associated with the TCI state. The UE would then be able to use a UE beam (e.g., DL Rx beam) corresponding to the base station beam to receive the DL transmission (e.g., given UE learns which UE beam corresponds to which DL RS (base station beam) based on measurement on the DL RS with different UE beams). Similarly, TCI states could be used to indicate UL Tx beams (UE beam) and/or UL Rx beams (base station beam). A Service Request Indicator (SRI) could also be used to indicate a UL beam. SRI could be associated with a Sounding Reference Signal (SRS) in an occasion transmitted with a UE beam (UL Tx beam). When a base station indicates an UL transmission is transmitted with a SRI, a UE would transmit the UL transmission with a beam same as used to transmit SRS in the occasion associated with the SRI (e.g., given base station learn which gNB beam (e.g., UL Rx beam) corresponds to which SRS (UE beam) based on measurement on SRS with different gNB beam). More details related to beam operation is given below from [4] 3GPP TS 38.214 V17.0.0, “NR Physical layer procedures for data”:

### Quotation Start

### 5.1.5 Antenna Ports Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. The UE can be configured with a list of up to M TCI-State configurations within the higher layer parameter PDSCH-Config-Multicast to decode PDSCH associated with a G-RNTI or a G-CS-RNTI according to a detected PDCCH with DCI intended for the UE and the given serving cell, where M′ depends on the UE capability. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}
   The UE can be configured with a list of up to [128] [TCI-State] configurations, within the higher layer parameter PDSCH-Config, with [tci-StateId_r17] that include [SourceRs-Info_r17] for providing a reference signal for the quasi-colocation for DM-RS of PDSCH and DM-RS of PDCCH in a CC, CSI-RS, and to provide a reference, if applicable, for determining UL TX spatial filter for dynamic-grant and configured-grant based PUSCH and PUCCH resource in a CC, and SRS. If the [TCI-State] configurations is absent in a BWP of the CC, the UE can apply the [TCI-State] configuration from a reference BWP of a reference CC.
   The UE receives an activation command, as described in clause 6.1.3.14 of [10, TS 38.321] or 6.1.3.x of [10, TS 38.321], used to map up to 8 TCI states and/or pairs of TCI states, with one TCI state for DL channels/signals and one TCI state for UL channels/signals to the codepoints of the DCI field ‘Transmission Configuration Indication’ for one or for a set of CCs/DL BWPs, and if applicable, for one or for a set of CCs/UL BPWs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs.
   If a UE is configured with the higher layer parameter tci-PresentInDCI that is set as ‘enabled’ for the CORESET scheduling a PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.
   If a PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [13, TS 38.306]. When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot with the scheduled PDSCH, and UE shall expect the activated TCI states are the same across the slots with the scheduled PDSCH.
   . . .

### 6.1 UE Procedure for Transmitting the Physical Uplink Shared Channel

PUSCH transmission(s) can be dynamically scheduled by an UL grant in a DCI, or the transmission can correspond to a configured grant Type 1 or Type 2. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI according to clause 10.2 of [6, TS 38.213] after the reception of higher layer parameter configuredGrantConfig not including rrc-ConfiguredUplinkGrant. If configuredGrantConfigToAddModList is configured, more than one configured grant configuration of configured grant Type 1 and/or configured grant Type 2 may be active at the same time on an active BWP of a serving cell.
When the UE is configured [TCI-State](s) with [tci-StateId_r17] for UL, the UE shall perform PUSCH transmission corresponding to a Type 1 configured grant or a Type 2 configured grant or a dynamic grant according to the spatial relation, if applicable, with a reference to the RS for determining UL Tx spatial filter or the RS configured with qcl-Type set to ‘typeD’ of the indicated [TCI-State] with [tci-StateId_r17]. The reference RS can be a CSI-RS resource in a NZP-CSI-RS-ResourceSet configured with higher layer parameter repetition, a CSI-RS resource in an NZP-CSI-RS-ResourceSet configured with higher layer parameter trs-Info or, in case [TCI-State] with [tci-StateId_r17] is for UL only, an SRS resource with the higher layer parameter usage set to ‘beamManagement’, or SS/PBCH block associated with the same or different PCI from the PCI of the serving cell.
A UE shall upon detection of a PDCCH with a configured DCI format 0_0, 0_1 or 0_2 transmit the corresponding PUSCH as indicated by that DCI unless the UE does not generate a transport block as described in [10, TS38.321].
For PUSCH scheduled by DCI format 0_0 on a cell, the UE shall transmit PUSCH according to the spatial relation, if applicable, corresponding to the dedicated PUCCH resource with the lowest ID within the active UL BWP of the cell, as described in Clause 9.2.1 of [6, TS 38.213]. If the dedicated PUCCH resource with the lowest ID within the active UL BWP of the cell corresponds to two spatial relations, the UE shall transmit the PUSCH according to the spatial relation with the lowest ID.
For PUSCH scheduled by DCI format 0_0 on a cell and if the higher layer parameter enableDefaultBeamPL-ForPUSCH0-0 is set ‘enabled’, the UE is not configured with PUCCH resources on the active UL BWP and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell. If the CORESET is indicated with two TCI states, sfnSchemePdcch is configured and the UE supports [DefaultBeamPL-ForPUSCH-SfnPdcch], the UE shall use the first TCI state as the QCL assumption.
For PUSCH scheduled by DCI format 0_0 on a cell and if the higher layer parameter enableDefaultBeamPL-ForPUSCH0-0 is set ‘enabled’, the UE is configured with PUCCH resources on the active UL BWP where all the PUCCH resource(s) are not configured with any spatial relation and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell in case CORESET(s) are configured on the cell.

### 6.1.1.1 Codebook Based UL Transmission

For codebook based transmission, PUSCH can be scheduled by DCI format 0_0, DCI format 0_1, DCI format 0_2 or semi-statically configured to operate according to Clause 6.1.2.3. If this PUSCH is scheduled by DCI format 0_1, DCI format 0_2, or semi-statically configured to operate according to Clause 6.1.2.3, the UE determines its PUSCH transmission precoder(s) based on SRI(s), TPMI(s) and the transmission rank, where the SRI(s), TPMI(s) and the transmission rank are given by DCI fields of one or two SRS resource indicators and one or two Precoding information and number of layers in clause 7.3.1.1.2 and 7.3.1.1.3 of [5, TS 38.212] for DCI format 0_1 and 0_2 or given by srs-ResourceIndicator and precodingAndNumberOfLayers according to clause 6.1.2.3 or given by srs-ResourceIndicator, srs-ResourceIndicator2, precodingAndNumberOfLayers, and precodingAndNumberOfLayers2 according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Only one or two SRS resource sets can be configured in srs-ResourceSetToAddModList with higher layer parameter usage in SRS-ResourceSet set to ‘codebook’, and only one or two SRS resource sets can be configured in srs-ResourceSetToAddModListDCI-0-2 with higher layer parameter usage in SRS-ResourceSet set to ‘codebook’.

### 6.1.1.2 Non-Codebook Based UL Transmission

For non-codebook based transmission, PUSCH can be scheduled by DCI format 0_0, DCI format 0_1, DCI format 0_2 or semi-statically configured to operate according to Clause 6.1.2.3. If this PUSCH is scheduled by DCI format 0_1, DCI format 0_2, or semi-statically configured to operate according to Clause 6.1.2.3, the UE can determine its PUSCH precoder(s) and transmission rank based on the SRI(s) when multiple SRS resources are configured, where the SRI(s) is given by one or two SRS resource indicator(s) in DCI according to clause 7.3.1.1.2 and 7.3.1.1.3 of [5, 38.212] for DCI format 0_1 and DCI format 0_2, or the SRI is given by srs-ResourceIndicator according to clause 6.1.2.3, or two SRIs given by srs-ResourceIndicator and srs-ResourceIndicator2 according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. The UE shall use one or multiple SRS resources for SRS transmission, where, in a SRS resource set, the maximum number of SRS resources which can be configured to the UE for simultaneous transmission in the same symbol and the maximum number of SRS resources are UE capabilities. The SRS resources transmitted simultaneously occupy the same RBs. Only one SRS port for each SRS resource is configured. Only one or two SRS resource sets can be configured in srs-ResourceSetToAddModList with higher layer parameter usage in SRS-ResourceSet set to ‘nonCodebook’, and only one or two SRS resource sets can be configured in srs-ResourceSetToAddModListDCI-0-2 with higher layer parameter usage in SRS-ResourceSet set to ‘nonCodebook’. When two SRS resource sets are configured in srs-ResourceSetToAddModList or srs-ResourceSetToAddModListDCI-0-2 with higher layer parameter usage in SRS-ResourceSet set to ‘nonCodebook’, one or two SRIs are given by the DCI fields of two SRS resource indicators in clause 7.3.1.1.2 and 7.3.1.1.3 of [5, TS 38.212] for DCI format 0_1 and 0_2. The UE applies the indicated SRI(s) to one or more PUSCH repetitions according to the associated SRS resource set of a PUSCH repetition according to clause 6.1.2.1. The maximum number of SRS resources per SRS resource set that can be configured for non-codebook based uplink transmission is 4. Each of the indicated one or two SRIs in slot n is associated with the most recent transmission of SRS resource(s) of associated SRS resource set identified by the SRI, where the SRS transmission is prior to the PDCCH carrying the SRI. When two SRS resource sets are configured in srs-ResourceSetToAddModList or srs-ResourceSetToAddModListDCI-0-2 with higher layer parameter usage in SRS-ResourceSet set to ‘nonCodebook’, the UE is not expected to be configured with different number of SRS resources in the two SRS resource sets.
When the PDCCH candidates are associated with a search space set configured with searchSpaceLinking, for the purpose of determining the most recent transmission of SRS resource(s) identified by the SRI, the PDCCH candidate that starts earlier in time among the two configured PDCCH candidates is used.
For non-codebook based transmission, the UE can calculate the precoder used for the transmission of SRS based on measurement of an associated NZP CSI-RS resource. A UE can be configured with only one NZP CSI-RS resource for the SRS resource set with higher layer parameter usage in SRS-ResourceSet set to ‘nonCodebook’ if configured.
The UE shall perform one-to-one mapping from the indicated SRI(s) to the indicated DM-RS ports(s) and their corresponding PUSCH layers {0 . . . v−1} given by DCI format 0_1 or 0_2 or by configuredGrantConfig according to clause 6.1.2.3 in increasing order.
The UE shall transmit PUSCH using the same antenna ports as the SRS port(s) in the SRS resource(s) indicated by SRI(s) given by DCI format 0_1 or 0_2 or by configuredGrantConfig according to clause 6.1.2.3, where the SRS port in (i+1)-th SRS resource in the SRS resource set is indexed as pᵢ=1000+i

### Quotation End

Duplexing enhancement has been discussed in 3GPP to enable more frequent UL so as to improve latency and UL coverage. UL transmission and DL transmission could occur on a same symbol for unpaired spectrum (e.g., TDD). More detail regarding duplexing could be found from below quotation from [3] RP-212707, “Draft SID on Evolution of NR Duplex Operation”:

### Quotation Start

TDD is widely used in commercial NR deployments. In TDD, the time domain resource is split between downlink and uplink Allocation of a limited time duration for the uplink in TDD would result in reduced coverage and increased latency. As a possible enhancement on this limitation of the conventional TDD operation, it would be worth studying the feasibility of allowing the simultaneous existence of downlink and uplink, a k a full duplex, or more specifically, subband non-overlapping full duplex at the gNB side within a conventional TDD band.
The NR TDD allows the dynamic/flexible allocation of downlink and uplink in time and CLI handling and RIM for NR were introduced in Rel-16. Nevertheless, further study may be required for CLI handling between the networks of different operators to enable the dynamic/flexible TDD in commercial networks. The inter-operator CLI may be due to either adjacent-channel CLI or co-channel-CLI, or both, depending on the deployment scenario. The main problem not addressed in the previous releases is gNB-to-gNB CLI.
This study aims to identify the feasibility and solutions of duplex evolution in the areas outlined above to provide enhanced coverage, reduced latency, improved system capacity, and improved configuration flexibility for NR TDD operations in unpaired spectrum.
In this study, the followings are assumed:
Duplex enhancement at the gNB side
Half duplex operation at the UE side
No restriction on frequency ranges
   The detailed objectives are as follows:
Study the subband non-overlapping full duplex and potential enhancements on dynamic/flexible TDD.
   Identify possible schemes and evaluate their feasibility and performances (RAND.
   Study inter-gNB and inter-UE CLI handling and identify solutions to manage them (RAN1).
      Study their impacts on inter-gNB interfaces if needed (RAN3).
      Consider intra-subband CLI and inter-subband CLI in case of the subband non-overlapping full duplex.
   Study the performance of the identified schemes as well as the impact on legacy operation assuming their co-existence in co-channel and adjacent channels (RAN1).
   Study the impact on RF requirements considering the self-interference, the inter-subband CLI, and the inter-operator CLI at gNB and the inter-subband CLI and inter-operator CLI at UE (RAN4).
   Study the impact on RF requirements considering adjacent-channel co-existence with the legacy operation (RAN4).
   RAN4 should be involved early to provide necessary information to RAN1 as needed and to study the feasibility aspects due to high impact in antenna/RF and algorithm design, which include antenna isolation, TX IM suppression in the RX part, filtering and digital interference suppression.

### Quotation End

Enhancements on duplexing schemes could impact how a User Equipment (UE) handles Downlink (DL) reception or Uplink (UL) transmission. For example, on a conventional DL symbol (e.g., without duplexing enhancement), a UE would not perform UL transmission on such symbol, e.g., cancel a configured UL transmission on the symbol or does not expect a Downlink Control Information (DCI) schedule UL transmission on the symbol (Network (NW) shall not perform such scheduling and/or a UE considers such scheduling as an error case.) Similar restriction on DL reception could be applied for a conventional UL symbol. The indicated transmission direction applies to all/whole frequency resources of a bandwidth part/serving cell. However, when one symbol could support more than one transmission direction, e.g., for both DL and UL, under duplexing enhancements such restriction may not hold any longer. For example, a UE may be able to perform UL transmission on a symbol indicated as DL. Whether duplexing enhancement is applicable may subject to isolation between DL transmission and UL reception at base station side. For example, when DL transmission is performed on one gNB beam and UL reception is performed on another gNB beam, the DL transmission and UL reception could occur on a same symbol, e.g., simultaneously, if the two gNB beams have good isolation, e.g., when there is less mutual interference. In other words, duplexing enhancement could be applicable. On the other hand, when the two gNB beams do not have good isolation, e.g., when there is more mutual interference, the DL transmission and UL reception could not occur on a same symbol, e.g., simultaneously. Duplexing enhancement is then not applicable. Given the corresponding UE behaviors are different, whether and/or how the UE realizes how duplexing enhancement is applied on the multiple beams and behave correctly, accordingly, may require some further considerations.

A first concept of the present invention is the base station indicates a UE which beam(s) is applicable for duplexing enhancement. On beams where duplexing enhancement is not applicable, transmission direction of one symbol could be (only) one of UL, DL, flexible, e.g., DL across a whole serving cell or bandwidth part. On beams where duplexing enhancement is applicable, transmission direction of one symbol could be more than one of UL, DL, flexible, e.g., UL on some frequency resources(s) and DL on other frequency resource(s) within a serving cell or bandwidth part.

A second concept of the present invention is to associate transmission direction(s) and/or Slot Format Indicator(s) (SFI(s)) on a symbol(s) with beam(s). In one example, a first transmission direction is associated with a first beam and/or a first set of beams. A second transmission direction is associated with a second beam and/or a second set of beams. A first SFI direction is associated with a first beam and/or a first set of beams. A second SFI is associated with a second beam and/or a second set of beams. The UE performs corresponding action for reception/transmission associated with the first beam and/or the first set of beams based on the first transmission direction and/or the first SFI. The UE performs corresponding action for reception/transmission associated with the second beam and/or the second set of beams based on the second transmission direction and/or the second SFI.

For example, for a first beam and/or a first set of beams a UE is indicated DL for a first frequency resource(s) for a symbol and is indicated UL for a second resource(s) for the symbol. For a second beam and/or a second set of beams, the UE is indicated DL for the symbol (e.g., for the first frequency resource(s) and/or the second resources). The UE would cancel a configured UL transmission on the symbol or consider a scheduled UL transmission on the symbol an error case if/when frequency resource of configured UL transmission or scheduled UL transmission is within the first frequency resource(s) and/or if/when the UL transmission is associated with the first beam and/or the first set of beams. The UE would perform a configured UL transmission or a scheduled UL transmission on the symbol if/when frequency resource of configured UL transmission or scheduled UL transmission is within the second frequency resource(s) and/or if/when the UL transmission is associated with the first beam and/or the first set of beams. The UE would cancel a configured UL transmission on the symbol or consider a scheduled UL transmission on the symbol an error case if/when the UL transmission is associated with the second beam and/or the second set of beams, e.g., irrespective of whether frequency resource of configured UL transmission or scheduled UL transmission is within the first frequency resource(s) and/or second frequency resource(s).

In another example, for a first beam and/or a first set of beams, a first transmission direction is associated with a first frequency resource(s). For a first beam and/or a first set of beams, the first transmission direction is not associated with a second frequency resource(s). For a second beam and/or a second set of beams, a second transmission direction is associated with the first frequency resource(s) and/or the second frequency resource(s). The second transmission direction could be the same as the first transmission direction. The second transmission direction could be different from the first transmission direction.

The UE performs corresponding action for reception/transmission within the first frequency resource(s) based on the first transmission direction if/when the reception/transmission is associated with the first beam and/or the first set of beams. The UE does not perform corresponding action for reception/transmission within the second frequency resource(s) based on the first transmission direction if/when the reception/transmission is associated with the first beam and/or the first set of beams. The UE performs corresponding action for reception/transmission based on the second transmission direction if/when the reception/transmission is associated with the second beam and/or the second set of beams (e.g., irrespective of within the first frequency resource(s) and/or the second frequency resource(s)).

For example, a UE is indicated DL for a first frequency resource(s) for a symbol for a first beam. The UE is indicated DL is not applied for a second frequency resource(s) for the symbol for the first beam. The UE is indicated DL is applied for the symbol for the second beam (e.g., for the first frequency resource(s) and/or the second frequency resource(s)) The UE would cancel a configured UL transmission on the symbol or consider a scheduled UL transmission on the symbol an error case if/when frequency resource of configured UL transmission or scheduled UL transmission is within the first frequency resource(s) and/or if/when the UL transmission is associated with the first beam. The UE behaves as if DL is not indicated for the symbol for a configured UL transmission or a scheduled UL transmission if/when frequency resource of configured UL transmission or scheduled UL transmission is within the second frequency resource(s) and/or if/when the UL transmission is associated with the first beam. The UE would perform a configured UL transmission or a scheduled UL transmission on the symbol if/when frequency resource of configured UL transmission or scheduled UL transmission is within the second frequency resource(s) and/or if/when the UL transmission is associated with the first beam. The UE would cancel a configured UL transmission on the symbol or consider a scheduled UL transmission on the symbol an error case if/when the UL transmission is associated with the second beam irrespective of whether frequency resource of configured UL transmission or scheduled UL transmission is within the first frequency resource(s) and/or the second frequency resource.

The first frequency resource(s) and or the second frequency resource(s) could be resources within a bandwidth part and/or a serving cell. The first frequency resource(s) and or the second frequency resource(s) could be all/whole resources within a bandwidth part and/or a serving cell. The UE could be indicated both the first frequency resource(s) and the second frequency resource(s). The UE could be indicated one of the first frequency resource(s) and the second frequency resource(s) and derive the other (e.g., the UE is indicated the first frequency resource(s) and frequency resource(s) of a serving cell/bandwidth part which is not within the first frequency resource(s) is the second frequency resource(s). The UE is indicated the second frequency resource(s) and frequency resource(s) of a serving cell/bandwidth part which is not within the second frequency resource(s) is the first frequency resource(s)). The UE may expect a reception/transmission would fall in either the first frequency resource(s) or the second frequency resource(s). The base station shall configure or schedule a transmission/reception so that frequency resource of a transmission/reception would fall in either the first frequency resource(s) or the second frequency resource(s). The base station shall configure or schedule a transmission/reception so that frequency resource of a transmission/reception is not across the first frequency resource(s) and the second frequency resource(s). When frequency resource of a transmission/reception is across the first frequency resource(s) and the second frequency resource(s), the UE may take one of the actions/behaviors related to first frequency resource(s)/second frequency resource(s) (e.g., as described above). For example, if the UE cancels reception/transmission in any part of the frequency resource(s), e.g., due to frequency resource of the reception/transmission overlapping with the first frequency resource(s) or the second frequency resource(s), the UE cancels the whole reception/transmission (e.g., instead of part of it). When frequency resource of a transmission/reception is across the first frequency resource(s) and the second frequency resource(s), the UE may take separate actions/behaviors for different frequency resource(s) of the transmission/reception (for example, cancel transmission/reception in part of the frequency resource(s) of the transmission/reception, and perform transmission/reception in other part of the frequency resource(s) of the transmission/reception).

Association between SFI/transmission direction and beam (or set of beams) could be indicated from a base station to a UE. The association could be configured via Radio Resource Control (RRC) signaling and/or indicated via Medium Access Control Control Element (MAC CE). The association could be indicated via DCI. The DCI could be monitored periodically. The DCI indicates the association for a certain time period. The DCI updates the association when the association is changed. The association could be indicated together with SFI. The association could be indicated separately from SFI. For example, a first SFI-Radio Network Temporary Identifier (RNTI) and/or a first location of SFI field could be associated with a first beam and/or a first set of beams. A second SFI-RNTI and/or a second location of SFI field could be associated with a second beam and/or a second set of beams. SFI indicated by DCI associated with the first SFI-RNTI and/or the first location of SFI field could be associated with the first frequency resource(s). SFI indicated by DCI associated with the second SFI-RNTI and/or the second location of SFI field could be associated with the second frequency resource(s). A bitmap associated with a SFI could be used to indicate beam and/or set of beams associated with the SFI. A Resource Indicator Value (RIV) value associated with a SFI could be used to indicate beam and/or set of beams associated with the SFI. A bandwidth part associated with a SFI could be used to indicate beam and/or set of beams associated with the SFI. A starting location(s) and a length(s) could be used to indicate the first frequency resource(s) and/or the second frequency resource(s). A starting Physical Resource Block(s) (PRB(s)) and a bandwidth(s) could be used to indicate the first frequency resource(s) and/or the second frequency resource(s).

Association between SFI/transmission direction and frequency resource could be indicated from a base station to a UE. The association could be configured via RRC signaling and/or indicated via MAC CE. The association could be indicated via DCI. The DCI could be monitored periodically. The DCI indicates the association for a certain time period. The DCI updates the association when the association is changed. The association could be indicated together with SFI. The association could be indicated separately from SFI. For example, a first SFI-RNTI and/or a first location of SFI field could be associated with a first frequency resource(s). A second SFI-RNTI and/or a second location of SFI field could be associated with a second frequency resource(s). SFI indicated by DCI associated with the first SFI-RNTI and/or the first location of SFI field could be associated with the first frequency resource(s). SFI indicated by DCI associated with the second SFI-RNTI and/or the second location of SFI field could be associated with the second frequency resource(s). A bitmap associated with a SFI could be used to indicate frequency resource associated with the SFI. A RIV value associated with a SFI could be used to indicate frequency resource associated with the SFI. A bandwidth part associated with a SFI could be used to indicate frequency resource associated with the SFI. A starting location(s) and a length(s) could be used to indicate the first frequency resource(s) and/or the second frequency resource(s). A starting PRB(s) and a bandwidth(s) could be used to indicate the first frequency resource(s) and/or the second frequency resource(s).

In one embodiment, a UE receives an indication whether duplexing enhancement is applicable for a beam (or a set of beams or not). The indication could indicate duplexing enhancement is applicable to which beam(s) and/or set of beams. The indication could indicate duplexing enhancement is not applicable to which beam(s) and/or set of beams. The indication could indicate duplexing enhancement is applicable to a first beam and/or a first set of beams. The indication could indicate duplexing enhancement is applicable to a second beam and/or a second set of beams. The first frequency resource(s) is associated with the first SFI. For a second beam and/or second set of beams, a UE does not receive indication of a first frequency resource(s) from a base station. The UE receives a first SFI for a first beam and/or first set of beams from the base station. The UE handles reception/transmission whose frequency resource(s) is within the first frequency resource(s) based on the first SFI when/if the reception/transmission is associated with the first beam and/or the first set of beams. The UE does not handle reception/transmission whose frequency resource(s) is not within the first frequency resource(s) based on the first SFI when/if the reception/transmission is associated with the first beam and/or the first set of beams. The UE handles reception/transmission whose frequency resource(s) is not within the first frequency resource(s) as if the first SFI is not indicated/present when/if the reception/transmission is associated with the first beam and/or the first set of beams. The UE cancels a configured (DL) reception on a symbol if/when the first SFI indicates the symbol as UL and frequency resource of the configured reception is within the first frequency resource(s) when/if the reception/transmission is associated with the first beam and/or the first set of beams. The UE performs a configured (DL) reception on a symbol if/when the first SFI indicates the symbol as UL and frequency resource of the configured reception is not within the first frequency resource(s) when/if the reception/transmission is associated with the first beam and/or the first set of beams. The UE cancels a configured (UL) transmission on a symbol if/when the first SFI indicates the symbol as DL and frequency resource of the configured transmission is within the first frequency resource(s) when/if the reception/transmission is associated with the first beam and/or the first set of beams. The UE performs a configured (UL) transmission on a symbol if/when the first SFI indicates the symbol as DL and frequency resource of the configured transmission is not within the first frequency resource(s) when/if the reception/transmission is associated with the first beam and/or the first set of beams. The UE does not expect to be scheduled (DL) reception on a symbol if/when the first SFI indicates the symbol as UL and frequency resource of the scheduled reception is within the first frequency resource(s) when/if the reception/transmission is associated with the first beam and/or the first set of beams. The UE is scheduled (DL) reception on a symbol if/when the first SFI indicates the symbol as UL and frequency resource of the configured reception is not within the first frequency resource(s) when/if the reception/transmission is associated with the first beam and/or the first set of beams. The UE does not expect to be scheduled (UL) transmission on a symbol if/when the first SFI indicates the symbol as DL and frequency resource of the scheduled transmission is within the first frequency resource(s) when/if the reception/transmission is associated with the first beam and/or the first set of beams. The UE is scheduled (UL) transmission on a symbol if/when the first SFI indicates the symbol as DL and frequency resource of the scheduled transmission is not within the first frequency resource(s) when/if the reception/transmission is associated with the first beam and/or the first set of beams. The UE receives indication of a second frequency resource(s) for the first beam and/or the first set of beams. The UE receives a second SFI for the first beam and/or the first set of beams. The second frequency resource is associated with the second SFI. The UE handles reception/transmission whose frequency resource(s) is within the second frequency resource(s) based on the second SFI. The UE cancels a configured (DL) reception on a symbol if/when the second SFI indicates the symbol as UL and frequency resource of the configured reception is within the second frequency resource(s) when/if the reception/transmission is associated with the first beam and/or the first set of beams. The UE cancels a configured (UL) transmission on a symbol if/when the second SFI indicates the symbol as DL and frequency resource of the configured transmission is within the second frequency resource(s) when/if the reception/transmission is associated with the first beam and/or the first set of beams. The UE does not expect to be scheduled (DL) reception on a symbol if/when the second SFI indicates the symbol as UL and frequency resource of the scheduled transmission is within the second frequency resource(s) when/if the reception/transmission is associated with the first beam and/or the first set of beams. The UE does not expect to be scheduled (UL) transmission on a symbol if/when the second SFI indicates the symbol as DL and frequency resource of the scheduled transmission is within the second frequency resource(s) when/if the reception/transmission is associated with the first beam and/or the first set of beams. The UE receives a third SFI for a second beam and/or second set of beams from the base station. The third SFI could be the same as the first SFI. The third SFI could be the same as the second SFI. The UE cancels a configured (UL) transmission on a symbol if/when the third SFI indicates the symbol as DL when/if the reception/transmission is associated with the second beam and/or the second set of beams. The UE performs a configured (UL) transmission on a symbol if/when the third SFI indicates the symbol as DL when/if the reception/transmission is associated with the second beam and/or the second set of beams. The UE does not expect to be scheduled (DL) reception on a symbol if/when the third SFI indicates the symbol as UL when/if the reception/transmission is associated with the second beam and/or the second set of beams. The UE is scheduled (DL) reception on a symbol if/when the third SFI indicates the symbol as UL when/if the reception/transmission is associated with the second beam and/or the second set of beams. The UE does not expect to be scheduled (UL) transmission on a symbol if/when the first SFI indicates the symbol as DL when/if the reception/transmission is associated with the second beam and/or the second set of beams. The UE is scheduled (UL) transmission on a symbol if/when the first SFI indicates the symbol as DL when/if the reception/transmission is associated with the second beam and/or the second set of beams.

In another embodiment, a base station transmits an indication whether duplexing enhancement is applicable for a beam (or a set of beams or not) to a UE. The indication could indicate duplexing enhancement is applicable to which beam(s) and/or set of beams. The indication could indicate duplexing enhancement is not applicable to which beam(s) and/or set of beams. The indication could indicate duplexing enhancement is applicable to a first beam and/or a first set of beams. The indication could indicate duplexing enhancement is applicable to a second beam and/or a second set of beams. The first frequency resource(s) is associated with the first SFI. For a second beam and/or second set of beams, a base station does not transmit indication of a first frequency resource(s) to a UE. The base station transmits a first SFI for a first beam and/or first set of beams to the UE. The base station handles reception/transmission whose frequency resource(s) is within the first frequency resource(s) based on the first SFI when/if the reception/transmission is associated with the first beam and/or the first set of beams. The base station does not handle reception/transmission whose frequency resource(s) is not within the first frequency resource(s) based on the first SFI when/if the reception/transmission is associated with the first beam and/or the first set of beams. The base station handles reception/transmission whose frequency resource(s) is not within the first frequency resource(s) as if the first SFI is not indicated/present when/if the reception/transmission is associated with the first beam and/or the first set of beams. The base station cancels a configured (DL) transmission on a symbol if/when the first SFI indicates the symbol as UL and frequency resource of the configured reception is within the first frequency resource(s) when/if the reception/transmission is associated with the first beam and/or the first set of beams. The base station performs a configured (DL) transmission on a symbol if/when the first SFI indicates the symbol as UL and frequency resource of the configured reception is not within the first frequency resource(s) when/if the reception/transmission is associated with the first beam and/or the first set of beams. The base station cancels a configured (UL) reception on a symbol if/when the first SFI indicates the symbol as DL and frequency resource of the configured transmission is within the first frequency resource(s) when/if the reception/transmission is associated with the first beam and/or the first set of beams. The base station performs a configured (UL) reception on a symbol if/when the first SFI indicates the symbol as DL and frequency resource of the configured transmission is not within the first frequency resource(s) when/if the reception/transmission is associated with the first beam and/or the first set of beams. The base station does not expect to schedule (DL) transmission on a symbol if/when the first SFI indicates the symbol as UL and frequency resource of the scheduled reception is within the first frequency resource(s) when/if the reception/transmission is associated with the first beam and/or the first set of beams. The base station schedules (DL) transmission on a symbol if/when the first SFI indicates the symbol as UL and frequency resource of the configured reception is not within the first frequency resource(s) when/if the reception/transmission is associated with the first beam and/or the first set of beams. The base station does not perform scheduled (UL) reception on a symbol if/when the first SFI indicates the symbol as DL and frequency resource of the scheduled transmission is within the first frequency resource(s) when/if the reception/transmission is associated with the first beam and/or the first set of beams The base station performs scheduled (UL) reception on a symbol if/when the first SFI indicates the symbol as DL and frequency resource of the scheduled transmission is not within the first frequency resource(s) when/if the reception/transmission is associated with the first beam and/or the first set of beams. The base station transmits indication of a second frequency resource(s) for the first beam and/or the first set of beams to the UE. The base station transmits a second SFI for the first beam and/or the first set of beams. The second frequency resource is associated with the second SFI. The UE handles reception/transmission whose frequency resource(s) is within the second frequency resource(s) based on the second SFI. The base station cancels a configured (DL) transmission on a symbol if/when the second SFI indicates the symbol as UL and frequency resource of the configured reception is within the second frequency resource(s) when/if the reception/transmission is associated with the first beam and/or the first set of beams. The base station cancels a configured (UL) reception on a symbol if/when the second SFI indicates the symbol as DL and frequency resource of the configured transmission is within the second frequency resource(s) when/if the reception/transmission is associated with the first beam and/or the first set of beams. The base station does not schedule (DL) transmission on a symbol if/when the second SFI indicates the symbol as UL and frequency resource of the scheduled transmission is within the second frequency resource(s) when/if the reception/transmission is associated with the first beam and/or the first set of beams. The base station does not schedule (UL) reception on a symbol if/when the second SFI indicates the symbol as DL and frequency resource of the scheduled transmission is within the second frequency resource(s) when/if the reception/transmission is associated with the first beam and/or the first set of beams. The base station transmits a third SFI for a second beam and/or second set of beams to the UE. The third SFI could be the same as the first SFI. The third SFI could be the same as the second SFI. The base station cancels a configured (UL) reception on a symbol if/when the third SFI indicates the symbol as DL when/if the reception/transmission is associated with the second beam and/or the second set of beams. The base station performs a configured (UL) reception on a symbol if/when the third SFI indicates the symbol as DL when/if the reception/transmission is associated with the second beam and/or the second set of beams. The base station does not schedule (DL) transmission on a symbol if/when the third SFI indicates the symbol as UL when/if the reception/transmission is associated with the second beam and/or the second set of beams. The base station schedules (DL) transmission on a symbol if/when the third SFI indicates the symbol as UL when/if the reception/transmission is associated with the second beam and/or the second set of beams. The base station does not schedule (UL) reception on a symbol if/when the first SFI indicates the symbol as DL when/if the reception/transmission is associated with the second beam and/or the second set of beams. The base station schedules (UL) reception on a symbol if/when the first SFI indicates the symbol as DL when/if the reception/transmission is associated with the second beam and/or the second set of beams.

Throughout the present disclosure, “beam” could be (replaced by) one or more of “base station beam (e.g., gNB beam)”, “UE beam”, “DL Rx beam”, “DL Rx beam”, “UL Tx beam”, “UL Rx beam”, “TCI state”, or “SRI”.

In various embodiments, collision handling rule(s) could be replaced with action(s) related to collision handling or behavior(s) related to collision handling.

In various embodiments, SFI could be replaced with a transmission direction.

In various embodiments, a transmission direction could be replaced with SFI.

In various embodiments, the invention describes behavior or operation of a single serving cell unless otherwise noted.

In various embodiments, the invention describes behavior or operation of multiple serving cells unless otherwise noted.

In various embodiments, the invention describes behavior or operation of a single bandwidth part unless otherwise noted.

In various embodiments, a base station configures multiple bandwidth parts to the UE unless otherwise noted.

In various embodiments, a base station configures a single bandwidth part to the UE unless otherwise noted.

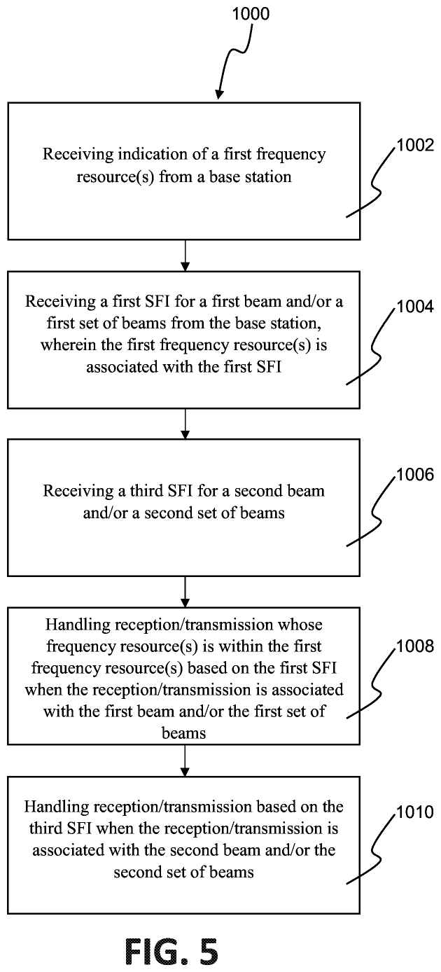

Referring to FIG. 5, with this and other concepts, systems, and methods of the present invention, a method 1000 for a UE in a wireless communication system comprises receiving indication of a first frequency resource(s) from a base station (step 1002), receiving a first SFI for a first beam and/or a first set of beams from the base station, wherein the first frequency resource(s) is associated with the first SFI (step 1004), receiving a third SFI for a second beam and/or a second set of beams (step 1006), handling reception/transmission whose frequency resource(s) is within the first frequency resource(s) based on the first SFI when the reception/transmission is associated with the first beam and/or the first set of beams (step 1008), and handling reception/transmission based on the third SFI when the reception/transmission is associated with the second beam and/or the second set of beams (step 1010).

In various embodiments, the first frequency resource(s) is a subset of frequency resource of a bandwidth part.

In various embodiments, the first frequency resource(s) is a subset of frequency resource of a serving cell.

In various embodiments, the UE does not handle reception/transmission whose frequency resource(s) is not within the first frequency resource(s) based on the first SFI when the reception/transmission is associated with the first beam and/or the first set of beams.

In various embodiments, the UE handles reception/transmission whose frequency resource(s) is not within the first frequency resource(s) as if the first SFI is not indicated/present when the reception/transmission is associated with the first beam and/or the first set of beams.

In various embodiments, the UE cancels a configured (DL) reception on a symbol if/when the first SFI indicates the symbol as UL and frequency resource of the configured reception is within the first frequency resource(s) when the reception/transmission is associated with the first beam and/or the first set of beams.

In various embodiments, the UE cancels a configured (UL) transmission on a symbol if/when the first SFI indicates the symbol as DL and frequency resource of the configured transmission is within the first frequency resource(s) when the reception/transmission is associated with the first beam and/or the first set of beams.

In various embodiments, the UE receives indication of a second frequency resource(s).

In various embodiments, the UE receives a second SFI for the first beam and/or the first set of beams and the second frequency resource is associated with the second SFI.

In various embodiments, the UE handles reception/transmission whose frequency resource(s) is within the second frequency resource(s) based on the second SFI when the reception/transmission is associated with the first beam and/or the first set of beams.

In various embodiments, the UE cancels a configured (DL) reception on a symbol if/when the second SFI indicates the symbol as UL and frequency resource of the configured reception is within the second frequency resource(s) when the reception/transmission is associated with the first beam and/or the first set of beams.

In various embodiments, the UE cancels a configured (UL) transmission on a symbol if/when the second SFI indicates the symbol as DL and frequency resource of the configured transmission is within the second frequency resource(s) when the reception/transmission is associated with the first beam and/or the first set of beams.

In various embodiments, the second frequency resource(s) is a subset of frequency resource of a bandwidth part.

In various embodiments, the second frequency resource(s) is a subset of frequency resource of a serving cell.

In various embodiments, the third SFI is associated with all resources of a bandwidth part.

Referring back to FIGS. 3 and 4, in one or more embodiments from the perspective of a UE, the device 300 includes a program code 312 stored in memory 310 of the transmitter. The CPU 308 could execute program code 312 to: (i) receive indication of a first frequency resource(s) from a base station; (ii) receive a first SFI for a first beam and/or a first set of beams from the base station, wherein the first frequency resource(s) is associated with the first SFI; (iii) receive a third SFI for a second beam and/or a second set of beams; (iv) handle reception/transmission whose frequency resource(s) is within the first frequency resource(s) based on the first SFI when the reception/transmission is associated with the first beam and/or the first set of beams; and (v) handle reception/transmission based on the third SFI when the reception/transmission is associated with the second beam and/or the second set of beams. Moreover, the CPU 308 can execute the program code 312 to perform all of the described actions, steps, and methods described above, below, or otherwise herein.

### Issues and Solutions:

Enhancements on duplexing schemes could have an impact on how a UE handles DL reception or UL transmission. For example, on a conventional DL symbol (e.g., without duplexing enhancement), a UE would not perform UL transmission on such symbol, e.g., cancel a configured UL transmission on the symbol or does not expect a DCI schedule UL transmission on the symbol (NW shall not perform such scheduling and/or UE consider such scheduling as an error case.) Similar restrictions on DL reception could be applied for a conventional UL symbol. The indicated transmission direction applies to all/whole frequency resources of a bandwidth part/serving cell. However, when one symbol could support more than one transmission direction, e.g., for both DL and UL, under duplexing enhancements, such restrictions may not hold any longer. For example, a UE may be able to perform UL transmission on a symbol indicated as DL. Whether duplexing enhancement is applicable may be subject to isolation between DL transmission and UL reception at the base station side. For example, when DL transmission is performed on one gNB beam and UL reception is performed on another gNB beam, the DL transmission and UL reception could occur on a same symbol, e.g., simultaneously, if the two gNB beams have good isolation, e.g., when there is less mutual interference. In other words, duplexing enhancement could be applicable. On the other hand, when the two gNB beams do not have good isolation, e.g., when there is more mutual interference, the DL transmission and UL reception could not occur on a same symbol, e.g., simultaneously. Duplexing enhancement is then not applicable. In other words, the handling of collision may be different when duplexing enhancement is applied or not for different beams. Some adjustment of collision handling rules in view of multiple beams between DL and UL would require some more thoughts.

A concept of the present invention is to determine whether/how to apply collision handling based on different cases and/or situations and/or factors. A UE determines a first collision handling rule under a first case. The UE determines a second collision handling rule under a second case. For example, a UE determines transmission direction (or SFI) of a symbol according to different transmission direction (or SFI) indicated for the symbol based on different cases and/or situations and/or factors. For example, a UE determines whether/how to handle reception/transmission on a symbol (according to transmission direction (or SFI) of a symbol) based on different cases and/or situations and/or factors. One example of the cases/factor could be a beam(s) associated a transmission/reception. A UE determines whether/how to handle reception/transmission on a symbol according to transmission direction (or SFI) of a symbol based on beam associated with the reception/transmission. The UE determines which collision handling rule(s) applies for reception/transmission based on beam associated with the reception/transmission. The UE determines a first collision handling rule(s) applies or a second collision handling rules applies for reception/transmission based on beam associated with the reception/transmission. The UE determines an old collision handling rule(s) applies or a new collision handling rules applies based on beam associated with the reception/transmission. The rule(s) applies to all time/frequency resources (e.g., all following resource(s) upon indication). The rule(s) applies to a subset of time resources (e.g., certain symbol(s) or slot(s)). The rules apply to a subset of time resources (e.g., certain PRB(s)/Bandwidth Part(s) (BWP(s)). The rules could be for enabling duplexing enhancement.

Another example of the cases/factors could be a type of SFI (or signaling indicating the SFI, such as common RRC signal, dedicated RRC signal, DCI format2_0, scheduling DCI . . . ). A UE determines whether/how to handle reception/transmission on a symbol (according to transmission direction (or SFI) of a symbol) based on a type of SFI. The UE determines which collision handling rule(s) applies based on type of SFI (e.g., SFI involved in the collision handling rules). The UE determines a first collision handling rule(s) applies or a second collision handling rules applies based on the type of SFI (e.g., SFI involved in the collision handling rules). The UE determines an old collision handling rule(s) applies or a new collision handling rules applies based type of SFI (e.g., SFI involved in the collision handling rules) For example, a UE applies a first/old collision handling rule(s) for SFI indicated by common RRC signal. The UE applies a second/new collision handling rule(s) for SFI indicated by dedicated RRC signal. A UE applies a collision handling rule(s) for SFI indicated by common RRC signal. The UE does not apply collision handling rule(s) for SFI indicated by dedicated RRC signal. A UE applies a first collision handling rule(s) for SFI indicated by RRC signal. The UE applies a second collision handling rule(s) for SFI indicated by scheduling DCI or DCI format 2_0. A UE applies a collision handling rule(s) for SFI indicated by RRC signal. The UE does not apply collision handling rule(s) for SFI indicated by scheduling DCI or DCI format 2_0. An example could be: A UE considers symbols in a slot indicated as downlink by tdd-UL-DL-ConfigurationCommon to be available for receptions (and not available for transmission) and considers symbols in a slot indicated as uplink by tdd-UL-DL-ConfigurationCommon, or by tdd-UL-DL-ConfigurationDedicated to be available for transmissions (and not available for reception). A UE considers symbols in a slot indicated as downlink by tdd-UL-DL-ConfigurationDedicated to be available for transmissions and considers symbols in a slot indicated as uplink by tdd-UL-DL-ConfigurationDedicated to be available for reception. Another example could be: For a set of symbols of a slot that are indicated to a UE as downlink by tdd-UL-DL-ConfigurationCommon, the UE does not transmit Physical Uplink Shared Channel (PUSCH), Physical Uplink Control Channel (PUCCH), Physical Random Access Channel (PRACH), or Sounding Reference Signal (SRS) when the PUSCH, PUCCH, PRACH, or SRS overlaps, even partially, with the set of symbols of the slot. For a set of symbols of a slot that are indicated to a UE as downlink by tdd-UL-DL-ConfigurationDedicated, the UE transmits PUSCH, PUCCH, PRACH, or SRS when the PUSCH, PUCCH, PRACH, or SRS overlaps, even partially, with the set of symbols of the slot. Another example of the cases/factor could be a type of reception/transmission (e.g., a DL reception, a UL transmission, a configured DL reception, a DL reception scheduled by DCI, a configured UL transmission, a UL transmission scheduled by DCI). A UE determines whether/how to handle reception/transmission on a symbol (according to transmission direction (or SFI) of a symbol) based on a type of reception/transmission. The UE determines which collision handling rule(s) applies for a reception transmission based on a type of reception/transmission. The UE determines a first collision handling rule(s) applies or a second collision handling rules applies based on a type of reception/transmission. The UE determines an old collision handling rule(s) applies or a new collision handling rules applies based a type of reception/transmission. For example, a UE applies a first/old collision handling rule(s) for a (DL) reception. The UE applies a second/new collision handling rule(s) for UL transmission. A UE applies a collision handling rule(s) for a (DL) reception. The UE does not apply collision handling rule(s) for a (DL) reception. A UE applies a first/old collision handling rule(s) for a (UL) configured transmission. The UE applies a second/new collision handling rule(s) for (UL) transmission scheduled by DCI. A UE applies a collision handling rule(s) for a (UL) configured transmission. The UE does not apply collision handling rule(s) for (UL) transmission scheduled by DCI. One example could be: for a set of symbols of a slot that are indicated to a UE as uplink by tdd-UL-DL-ConfigurationCommon the UE does not receive Physical Downlink Control Channel (PDCCH), Physical Downlink Shared Channel (PDSCH), or Channel State Information Reference Signal (CSI-RS) when the PDCCH, PDSCH, or CSI-RS overlaps, even partially, with the set of symbols of the slot. For a set of symbols of a slot that are indicated to a UE as downlink by tdd-UL-DL-ConfigurationCommon, the UE transmits PUSCH, PUCCH, PRACH, or SRS when the PUSCH, PUCCH, PRACH, or SRS overlaps, even partially, with the set of symbols of the slot. Another example: for a set of symbols of a slot that are indicated to a UE as downlink by tdd-UL-DL-ConfigurationCommon, the UE does not transmit PUSCH, PUCCH, PRACH, or SRS when the PUSCH, PUCCH, PRACH, or SRS overlaps, even partially, with the set of symbols of the slot wherein the PUSCH, PUCCH, PRACH, or SRS are configured to transmit. For a set of symbols of a slot that are indicated to a UE as downlink by tdd-UL-DL-ConfigurationCommon, the UE does not transmit PUSCH, PUCCH, PRACH, or SRS when the PUSCH, PUCCH, PRACH, or SRS overlaps, even partially, with the set of symbols of the slot wherein the PUSCH, PUCCH, PRACH, or SRS are scheduled by a DCI.

All or some of the cases/factors above and herein could be combined to form a new method.

A collision handling rule (or a first/old collision handling rule, a first action related to collision handling) could be one or more of the following (e.g., the following refers to a behavior “apply collision handling rule” or “collision rule is enabled” as described above/throughout the disclosure), e.g., as what has been quoted from 11.1/11.1.1 of TS 38.213:
If the UE is additionally provided tdd-UL-DL-ConfigurationDedicated, the parameter tdd-UL-DL-ConfigurationDedicated overrides only flexible symbols per slot over the number of slots as provided by tdd-UL-DL-ConfigurationCommon.
For each slot having a corresponding index provided by slotIndex, the UE applies a format provided by corresponding symbols. The UE does not expect tdd-UL-DL-ConfigurationDedicated to indicate as uplink or as downlink a symbol that tdd-UL-DL-ConfigurationCommon indicates as a downlink or as an uplink symbol, respectively.
A slot configuration period and a number of downlink symbols, uplink symbols, and flexible symbols in each slot of the slot configuration period are determined from tdd-UL-DL-ConfigurationCommon and tdd-UL-DL-ConfigurationDedicated and are common to each configured BWP.
A UE considers symbols in a slot indicated as downlink by tdd-UL-DL-ConfigurationCommon, or tdd-UL-DL-ConfigurationDedicated to be available for receptions and considers symbols in a slot indicated as uplink by tdd-UL-DL-ConfigurationCommon, or by tdd-UL-DL-ConfigurationDedicated to be available for transmissions.
If a UE is not configured to monitor PDCCH for DCI format 2_0, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, the UE receives PDSCH or CSI-RS in the set of symbols of the slot if the UE receives a corresponding indication by a DCI format.
If a UE is not configured to monitor PDCCH for DCI format 2_0, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, the UE transmits PUSCH, PUCCH, PRACH, or SRS in the set of symbols of the slot if the UE receives a corresponding indication by a DCI format, a Random Access Response (RAR) UL grant, fallbackRAR UL grant, or successRAR.
For operation on a single carrier in unpaired spectrum, if a UE is configured by higher layers to receive a PDCCH, or a PDSCH, or a CSI-RS, or a DL Positioning Reference Signal (PRS) in a set of symbols of a slot, the UE receives the PDCCH, the PDSCH, the CSI-RS, or the DL PRS if the UE does not detect a DCI format that indicates to the UE to transmit a PUSCH, a PUCCH, a PRACH, or a SRS in at least one symbol of the set of symbols of the slot; otherwise, the UE does not receive the PDCCH, or the PDSCH, or the CSI-RS, or the DL PRS in the set of symbols of the slot.
For operation on a single carrier in unpaired spectrum, if a UE is configured by higher layers to transmit SRS, or PUCCH, or PUSCH, or PRACH in a set of symbols of a slot and the UE detects a DCI format indicating to the UE to receive CSI-RS or PDSCH in a subset of symbols from the set of symbols then: If the UE does not indicate the capability of [partialCancellation], the UE does not expect to cancel the transmission of the PUCCH or PUSCH or PRACH in the set of symbols if the first symbol in the set occurs within T_(proc,2) relative to a last symbol of a CORESET where the UE detects the DCI format; otherwise, the UE cancels the PUCCH, or the PUSCH, or an actual repetition of the PUSCH (e.g., TS38.214), determined from clauses 9 and 9.2.5 or clause 6.1 of TS38.214, or the PRACH transmission in the set of symbols.
For operation on a single carrier in unpaired spectrum, if a UE is configured by higher layers to transmit SRS, or PUCCH, or PUSCH, or PRACH in a set of symbols of a slot and the UE detects a DCI format indicating to the UE to receive CSI-RS or PDSCH in a subset of symbols from the set of symbols, then: If the UE indicates the capability of [partialCancellation], the UE does not expect to cancel the transmission of the PUCCH or PUSCH or PRACH in symbols from the set of symbols that occur within T_{proc,2} relative to a last symbol of a Control Resource Set (CORESET) where the UE detects the DCI format. The UE cancels the PUCCH, or the PUSCH, or an actual repetition of the PUSCH (e.g., TS 38.214), determined from clauses 9 and 9.2.5 or clause 6.1 of TS 38.214, or the PRACH transmission in remaining symbols from the set of symbols.
For operation on a single carrier in unpaired spectrum, if a UE is configured by higher layers to transmit SRS, or PUCCH, or PUSCH, or PRACH in a set of symbols of a slot and the UE detects a DCI format indicating to the UE to receive CSI-RS or PDSCH in a subset of symbols from the set of symbols then: The UE does not expect to cancel the transmission of SRS in symbols from the subset of symbols that occur within T_(proc,2) relative to a last symbol of a CORESET where the UE detects the DCI format. The UE cancels the SRS transmission in remaining symbols from the subset of symbols.
For a set of symbols of a slot that are indicated to a UE as uplink by tdd-UL-DL-ConfigurationCommon the UE does not receive PDCCH, PDSCH, or CSI-RS when the PDCCH, PDSCH, or CSI-RS overlaps, even partially, with the set of symbols of the slot.
For a set of symbols of a slot that are indicated to a UE as uplink by tdd-UL-DL-ConfigurationDedicated, the UE does not receive PDCCH, PDSCH, or CSI-RS when the PDCCH, PDSCH, or CSI-RS overlaps, even partially, with the set of symbols of the slot.
For a set of symbols of a slot that are indicated to a UE as uplink by tdd-UL-DL-ConfigurationCommon, the UE does not receive DL PRS in the set of symbols of the slot, if the UE is not provided with a measurement gap.
For a set of symbols of a slot that are indicated to a UE as uplink by tdd-UL-DL-ConfigurationDedicated, the UE does not receive DL PRS in the set of symbols of the slot, if the UE is not provided with a measurement gap.
For a set of symbols of a slot that are indicated to a UE as downlink by tdd-UL-DL-ConfigurationCommon, the UE does not transmit PUSCH, PUCCH, PRACH, or SRS when the PUSCH, PUCCH, PRACH, or SRS overlaps, even partially, with the set of symbols of the slot.
For a set of symbols of a slot that are indicated to a UE as downlink by tdd-UL-DL-ConfigurationDedicated, the UE does not transmit PUSCH, PUCCH, PRACH, or SRS when the PUSCH, PUCCH, PRACH, or SRS overlaps, even partially, with the set of symbols of the slot.
For a set of symbols of a slot that are indicated to a UE as flexible by tdd-UL-DL-ConfigurationCommon, and tdd-UL-DL-ConfigurationDedicated if provided, the UE does not expect to receive both dedicated higher layer parameters configuring transmission from the UE in the set of symbols of the slot and dedicated higher layer parameters configuring reception by the UE in the set of symbols of the slot.
For operation on a single carrier in unpaired spectrum, for a set of symbols of a slot indicated to a UE by ssb-PositionsInBurst in SIB1 or ssb-PositionsInBurst in Serving CellConfigCommon, for reception of Synchronized/Physical Broadcast Channel (SS/PBCH) blocks, the UE does not transmit PUSCH, PUCCH, PRACH in the slot if a transmission would overlap with any symbol from the set of symbols and the UE does not transmit SRS in the set of symbols of the slot. The UE does not expect the set of symbols of the slot to be indicated as uplink by tdd-UL-DL-ConfigurationCommon, or tdd-UL-DL-ConfigurationDedicated, when provided to the UE.
For a set of symbols of a slot corresponding to a valid PRACH occasion and N_{gap} symbols before the valid PRACH occasion, as described in clause 8.1, the UE does not receive PDCCH, PDSCH, or CSI-RS in the slot if a reception would overlap with any symbol from the set of symbols. The UE does not expect the set of symbols of the slot to be indicated as downlink by tdd-UL-DL-ConfigurationCommon or tdd-UL-DL-ConfigurationDedicated.
For a set of symbols of a slot indicated to a UE by pdcch-ConfigSIB1 in MIB for a CORESET for Type0-PDCCH Common Search Space (CSS) set, the UE does not expect the set of symbols to be indicated as uplink by tdd-UL-DL-ConfigurationCommon, or tdd-UL-DL-ConfigurationDedicated.
If a UE is scheduled by a DCI format to receive PDSCH over multiple slots, and if tdd-UL-DL-ConfigurationCommon indicate that, for a slot from the multiple slots, at least one symbol from a set of symbols where the UE is scheduled PDSCH reception in the slot is an uplink symbol, the UE does not receive the PDSCH in the slot.
If a UE is scheduled by a DCI format to receive PDSCH over multiple slots, and if tdd-UL-DL-ConfigurationDedicated, indicate that, for a slot from the multiple slots, at least one symbol from a set of symbols where the UE is scheduled PDSCH reception in the slot is an uplink symbol, the UE does not receive the PDSCH in the slot.
If a UE is scheduled by a DCI format to transmit PUSCH over multiple slots, and if tdd-UL-DL-ConfigurationCommon, indicates that, for a slot from the multiple slots, at least one symbol from a set of symbols where the UE is scheduled PUSCH transmission in the slot is a downlink symbol, the UE does not transmit the PUSCH in the slot.
If a UE is scheduled by a DCI format to transmit PUSCH over multiple slots, and if tdd-UL-DL-ConfigurationDedicated, indicates that, for a slot from the multiple slots, at least one symbol from a set of symbols where the UE is scheduled PUSCH transmission in the slot is a downlink symbol, the UE does not transmit the PUSCH in the slot.
For a set of symbols of a slot, a UE does not expect to detect a DCI format 2_0 with an SFI-index field value indicating the set of symbols of the slot as uplink and to detect a DCI format indicating to the UE to receive PDSCH or CSI-RS in the set of symbols of the slot.
For a set of symbols of a slot, a UE does not expect to detect a DCI format 2_0 with an SFI-index field value indicating the set of symbols in the slot as downlink and to detect a DCI format, a RAR UL grant, fallbackRAR UL grant, or successRAR indicating to the UE to transmit PUSCH, PUCCH, PRACH, or SRS in the set of symbols of the slot.
For a set of symbols of a slot that are indicated as downlink/uplink by tdd-UL-DL-ConfigurationCommon, or tdd-UL-DL-ConfigurationDedicated, the UE does not expect to detect a DCI format 2_0 with an SFI-index field value indicating the set of symbols of the slot as uplink/downlink, respectively, or as flexible.
For a set of symbols of a slot corresponding to SS/PBCH blocks with candidate SS/PBCH block indices corresponding to the SS/PBCH block indexes indicated to a UE by ssb-PositionsInBurst in SIB1, or by ssb-PositionsInBurst in ServingCellConfigCommon, as described in clause 4.1, the UE does not expect to detect a DCI format 2_0 with an SFI-index field value indicating the set of symbols of the slot as uplink.
For a set of symbols of a slot corresponding to a valid PRACH occasion and N_{gap} symbols before the valid PRACH occasion, as described in clause 8.1, the UE does not expect to detect a DCI format 2_0 with an SFI-index field value indicating the set of symbols of the slot as downlink.
For a set of symbols of a slot indicated to a UE by pdcch-ConfigSIB1 in MIB for a CORESET for Type0-PDCCH CSS set, the UE does not expect to detect a DCI format 2_0 with an SFI-index field value indicating the set of symbols of the slot as uplink.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if one or more symbols from the set of symbols are symbols in a CORESET configured to the UE for PDCCH monitoring, the UE receives PDCCH in the CORESET only if an SFI-index field value in DCI format 2_0 indicates that the one or more symbols are downlink symbols.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if an SFI-index field value in DCI format 2_0 indicates the set of symbols of the slot as flexible and the UE detects a DCI format indicating to the UE to receive PDSCH or CSI-RS in the set of symbols of the slot, the UE receives PDSCH or CSI-RS in the set of symbols of the slot.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if an SFI-index field value in DCI format 2_0 indicates the set of symbols of the slot as flexible and the UE detects a DCI format, a RAR UL grant, fallbackRAR UL grant, or successRAR indicating to the UE to transmit PUSCH, PUCCH, PRACH, or SRS in the set of symbols of the slot the UE transmits the PUSCH, PUCCH, PRACH, or SRS in the set of symbols of the slot.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if an SFI-index field value in DCI format 2_0 indicates the set of symbols of the slot as flexible, and the UE does not detect a DCI format indicating to the UE to receive PDSCH or CSI-RS, or the UE does not detect a DCI format, a RAR UL, fallbackRAR UL grant, or successRAR grant indicating to the UE to transmit PUSCH, PUCCH, PRACH, or SRS in the set of symbols of the slot, the UE does not transmit or receive in the set of symbols of the slot.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if the UE is configured by higher layers to receive DL PRS in the set of symbols of the slot, the UE receives the DL PRS in the set of symbols of the slot only if an SFI-index field value in DCI format 2_0 indicates the set of symbols of the slot as downlink or flexible.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if the UE is configured by higher layers to transmit PUCCH, or PUSCH, or PRACH in the set of symbols of the slot, the UE transmits the PUCCH, or the PUSCH, or the PRACH in the slot only if an SFI-index field value in DCI format 2_0 indicates the set of symbols of the slot as uplink.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if the UE is configured by higher layers to transmit SRS in the set of symbols of the slot, the UE transmits the SRS only in a subset of symbols from the set of symbols of the slot indicated as uplink symbols by an SFI-index field value in DCI format 2_0.

An exception/exemption of collision a handling rule (or a new/second collision handling rule or a second action related to collision handling) could be one or more of the following (e.g., the following refers to a behavior “not apply collision handling rule” or “collision rule is disabled” as described above/throughout the invention):
If the UE is additionally provided tdd-UL-DL-ConfigurationDedicated, the parameter tdd-UL-DL-ConfigurationDedicated overrides DL symbols per slot over the number of slots as provided by tdd-UL-DL-ConfigurationCommon.
If the UE is additionally provided tdd-UL-DL-ConfigurationDedicated, the parameter tdd-UL-DL-ConfigurationDedicated overrides UL symbols per slot over the number of slots as provided by tdd-UL-DL-ConfigurationCommon.
For each slot having a corresponding index provided by slotIndex, the UE applies a format provided by corresponding symbols. The UE receives tdd-UL-DL-ConfigurationDedicated to indicate as uplink symbol that tdd-UL-DL-ConfigurationCommon indicates as a downlink symbol.
For each slot having a corresponding index provided by slotIndex, the UE applies a format provided by corresponding symbols. The UE receives tdd-UL-DL-ConfigurationDedicated to indicate as downlink symbol that tdd-UL-DL-ConfigurationCommon indicates as an uplink symbol.
A slot configuration period and a number of downlink symbols, uplink symbols, and flexible symbols in each slot of the slot configuration period are determined from tdd-UL-DL-ConfigurationCommon and tdd-UL-DL-ConfigurationDedicated and are different to different configured BWPs (i.e., each BWP has its own slot configuration).
A UE considers symbols in a slot indicated as uplink by tdd-UL-DL-ConfigurationCommon, or tdd-UL-DL-ConfigurationDedicated to be available for receptions.
A UE considers symbols in a slot indicated as downlink by tdd-UL-DL-ConfigurationCommon, or by tdd-UL-DL-ConfigurationDedicated to be available for transmissions.
If a UE is not configured to monitor PDCCH for DCI format 2_0, for a set of symbols of a slot that are indicated as uplink by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, the UE receives PDSCH or CSI-RS in the set of symbols of the slot if the UE receives a corresponding indication by a DCI format.
If a UE is not configured to monitor PDCCH for DCI format 2_0, for a set of symbols of a slot that are indicated as downlink by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, the UE transmits PUSCH, PUCCH, PRACH, or SRS in the set of symbols of the slot if the UE receives a corresponding indication by a DCI format, a RAR UL grant, fallbackRAR UL grant, or successRAR.
For operation on a single carrier in unpaired spectrum, if a UE is configured by higher layers to receive a PDCCH, or a PDSCH, or a CSI-RS, or a DL PRS in a set of symbols of a slot, the UE receives the PDCCH, the PDSCH, the CSI-RS, or the DL PRS if the UE detects a DCI format that indicates to the UE to transmit a PUSCH, a PUCCH, a PRACH, or a SRS in at least one symbol of the set of symbols of the slot.
For operation on a single carrier in unpaired spectrum, if a UE is configured by higher layers to transmit SRS, or PUCCH, or PUSCH, or PRACH in a set of symbols of a slot and the UE detects a DCI format indicating to the UE to receive CSI-RS or PDSCH in a subset of symbols from the set of symbols then: If the UE does not indicate the capability of [partialCancellation], the UE transmits the PUCCH, or the PUSCH, or an actual repetition of the PUSCH (e.g., TS 38.214), determined from clauses 9 and 9.2.5 or clause 6.1 of TS 38.214, or the PRACH transmission in the set of symbols.
For operation on a single carrier in unpaired spectrum, if a UE is configured by higher layers to transmit SRS, or PUCCH, or PUSCH, or PRACH in a set of symbols of a slot and the UE detects a DCI format indicating to the UE to receive CSI-RS or PDSCH in a subset of symbols from the set of symbols, then: If the UE indicates the capability of [partialCancellation], the UE transmits the PUCCH, or the PUSCH, or an actual repetition of the PUSCH (e.g., TS 38.214), determined from clauses 9 and 9.2.5 or clause 6.1 of TS 38.214, or the PRACH transmission in the set of symbols.
For operation on a single carrier in unpaired spectrum, if a UE is configured by higher layers to transmit SRS, or PUCCH, or PUSCH, or PRACH in a set of symbols of a slot and the UE detects a DCI format indicating to the UE to receive CSI-RS or PDSCH in a subset of symbols from the set of symbols then: The UE transmit SRS in the subset of symbols.
For a set of symbols of a slot that are indicated to a UE as uplink by tdd-UL-DL-ConfigurationCommon the UE receives PDCCH, PDSCH, or CSI-RS when the PDCCH, PDSCH, or CSI-RS overlaps, even partially, with the set of symbols of the slot.
For a set of symbols of a slot that are indicated to a UE as uplink by tdd-UL-DL-ConfigurationDedicated, the UE receives PDCCH, PDSCH, or CSI-RS when the PDCCH, PDSCH, or CSI-RS overlaps, even partially, with the set of symbols of the slot.
For a set of symbols of a slot that are indicated to a UE as uplink by tdd-UL-DL-ConfigurationCommon, the UE receives DL PRS in the set of symbols of the slot, if the UE is not provided with a measurement gap.
For a set of symbols of a slot that are indicated to a UE as uplink by tdd-UL-DL-ConfigurationDedicated, the UE receives DL PRS in the set of symbols of the slot, if the UE is not provided with a measurement gap.
For a set of symbols of a slot that are indicated to a UE as downlink by tdd-UL-DL-ConfigurationCommon, the UE transmits PUSCH, PUCCH, PRACH, or SRS when the PUSCH, PUCCH, PRACH, or SRS overlaps, even partially, with the set of symbols of the slot.
For a set of symbols of a slot that are indicated to a UE as downlink by tdd-UL-DL-ConfigurationDedicated, the UE transmits PUSCH, PUCCH, PRACH, or SRS when the PUSCH, PUCCH, PRACH, or SRS overlaps, even partially, with the set of symbols of the slot.
For a set of symbols of a slot that are indicated to a UE as flexible by tdd-UL-DL-ConfigurationCommon, and tdd-UL-DL-ConfigurationDedicated if provided, the UE receives both dedicated higher layer parameters configuring transmission from the UE in the set of symbols of the slot and dedicated higher layer parameters configuring reception by the UE in the set of symbols of the slot.
For operation on a single carrier in unpaired spectrum, for a set of symbols of a slot indicated to a UE by ssb-PositionsInBurst in SIB1 or ssb-PositionsInBurst in Serving CellConfigCommon, for reception of SS/PBCH blocks, the UE transmits PUSCH, PUCCH, PRACH in the slot if a transmission would overlap with any symbol from the set of symbols and the UE transmits SRS in the set of symbols of the slot. The set of symbols of the slot is indicated as uplink by tdd-UL-DL-ConfigurationCommon, or tdd-UL-DL-ConfigurationDedicated, when provided to the UE.
For a set of symbols of a slot corresponding to a valid PRACH occasion and N_{gap} symbols before the valid PRACH occasion, as described in clause 8.1, the UE receives PDCCH, PDSCH, or CSI-RS in the slot if a reception would overlap with any symbol from the set of symbols. The set of symbols of the slot is indicated as downlink by tdd-UL-DL-ConfigurationCommon or tdd-UL-DL-ConfigurationDedicated.
For a set of symbols of a slot indicated to a UE by pdcch-ConfigSIB1 in MIB for a CORESET for Type0-PDCCH CSS set, the set of symbols is indicated as uplink by tdd-UL-DL-ConfigurationCommon, or tdd-UL-DL-ConfigurationDedicated.
If a UE is scheduled by a DCI format to receive PDSCH over multiple slots, and if tdd-UL-DL-ConfigurationCommon indicate that, for a slot from the multiple slots, at least one symbol from a set of symbols where the UE is scheduled PDSCH reception in the slot is an uplink symbol, the UE receives the PDSCH in the slot.
If a UE is scheduled by a DCI format to receive PDSCH over multiple slots, and if tdd-UL-DL-ConfigurationDedicated, indicate that, for a slot from the multiple slots, at least one symbol from a set of symbols where the UE is scheduled PDSCH reception in the slot is an uplink symbol, the UE receives the PDSCH in the slot.
If a UE is scheduled by a DCI format to transmit PUSCH over multiple slots, and if tdd-UL-DL-ConfigurationCommon, indicates that, for a slot from the multiple slots, at least one symbol from a set of symbols where the UE is scheduled PUSCH transmission in the slot is a downlink symbol, the UE transmits the PUSCH in the slot.
If a UE is scheduled by a DCI format to transmit PUSCH over multiple slots, and if tdd-UL-DL-ConfigurationDedicated, indicates that, for a slot from the multiple slots, at least one symbol from a set of symbols where the UE is scheduled PUSCH transmission in the slot is a downlink symbol, the UE transmits the PUSCH in the slot.
For a set of symbols of a slot, a UE detects a DCI format 2_0 with an SFI-index field value indicating the set of symbols of the slot as uplink and detects a DCI format indicating to the UE to receive PDSCH or CSI-RS in the set of symbols of the slot.
For a set of symbols of a slot, a UE detects a DCI format 2_0 with an SFI-index field value indicating the set of symbols in the slot as downlink and detects a DCI format, a RAR UL grant, fallbackRAR UL grant, or successRAR indicating to the UE to transmit PUSCH, PUCCH, PRACH, or SRS in the set of symbols of the slot.
For a set of symbols of a slot that are indicated as downlink by tdd-UL-DL-ConfigurationCommon, the UE does not expect to detect a DCI format 2_0 with an SFI-index field value indicating the set of symbols of the slot as uplink, respectively, or as flexible.
For a set of symbols of a slot that are indicated as downlink by tdd-UL-DL-ConfigurationDedicated, the UE does not expect to detect a DCI format 2_0 with an SFI-index field value indicating the set of symbols of the slot as uplink, respectively, or as flexible.
For a set of symbols of a slot that are indicated as uplink by tdd-UL-DL-ConfigurationCommon, the UE does not expect to detect a DCI format 2_0 with an SFI-index field value indicating the set of symbols of the slot as downlink, respectively, or as flexible.
For a set of symbols of a slot that are indicated as uplink by tdd-UL-DL-ConfigurationDedicated, the UE does not expect to detect a DCI format 2_0 with an SFI-index field value indicating the set of symbols of the slot as downlink, respectively, or as flexible.
For a set of symbols of a slot corresponding to SS/PBCH blocks with candidate SS/PBCH block indices corresponding to the SS/PBCH block indexes indicated to a UE by ssb-PositionsInBurst in SIB1, or by ssb-PositionsInBurst in ServingCellConfigCommon, as described in clause 4.1, the UE detects a DCI format 2_0 with an SFI-index field value indicating the set of symbols of the slot as uplink.
For a set of symbols of a slot corresponding to a valid PRACH occasion and N_{gap} symbols before the valid PRACH occasion, as described in clause 8.1, the UE detects a DCI format 2_0 with an SFI-index field value indicating the set of symbols of the slot as downlink
For a set of symbols of a slot indicated to a UE by pdcch-ConfigSIB1 in MIB for a CORESET for Type0-PDCCH CSS set, the UE detects a DCI format 2_0 with an SFI-index field value indicating the set of symbols of the slot as uplink.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if one or more symbols from the set of symbols are symbols in a CORESET configured to the UE for PDCCH monitoring, the UE receives PDCCH in the CORESET if an SFI-index field value in DCI format 2_0 indicates that the one or more symbols are flexible symbols.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if one or more symbols from the set of symbols are symbols in a CORESET configured to the UE for PDCCH monitoring, the UE receives PDCCH in the CORESET if an SFI-index field value in DCI format 2_0 indicates that the one or more symbols are uplink symbols.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if an SFI-index field value in DCI format 2_0 indicates the set of symbols of the slot as uplink and the UE detects a DCI format indicating to the UE to receive PDSCH or CSI-RS in the set of symbols of the slot, the UE receives PDSCH or CSI-RS in the set of symbols of the slot.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if an SFI-index field value in DCI format 2_0 indicates the set of symbols of the slot as downlink and the UE detects a DCI format, a RAR UL grant, fallbackRAR UL grant, or successRAR indicating to the UE to transmit PUSCH, PUCCH, PRACH, or SRS in the set of symbols of the slot the UE transmits the PUSCH, PUCCH, PRACH, or SRS in the set of symbols of the slot.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if an SFI-index field value in DCI format 2_0 indicates the set of symbols of the slot as flexible, and the UE detects a DCI format indicating to the UE to receive PDSCH or CSI-RS, and the UE detects a DCI format, a RAR UL, fallbackRAR UL grant, or successRAR grant indicating to the UE to transmit PUSCH, PUCCH, PRACH, or SRS in the set of symbols of the slot, the UE transmits and receives in the set of symbols of the slot.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if the UE is configured by higher layers to receive DL PRS in the set of symbols of the slot, the UE receives the DL PRS in the set of symbols of the slot if an SFI-index field value in DCI format 2_0 indicates the set of symbols of the slot as uplink
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if the UE is configured by higher layers to transmit PUCCH, or PUSCH, or PRACH in the set of symbols of the slot, the UE transmits the PUCCH, or the PUSCH, or the PRACH in the slot if an SFI-index field value in DCI format 2_0 indicates the set of symbols of the slot as flexible.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if the UE is configured by higher layers to transmit PUCCH, or PUSCH, or PRACH in the set of symbols of the slot, the UE transmits the PUCCH, or the PUSCH, or the PRACH in the slot if an SFI-index field value in DCI format 2_0 indicates the set of symbols of the slot as downlink
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if the UE is configured by higher layers to transmit SRS in the set of symbols of the slot, the UE transmits the SRS in the set of symbols of the slot indicated as flexible symbols by an SFI-index field value in DCI format 2_0.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: if the UE is configured by higher layers to transmit SRS in the set of symbols of the slot, the UE transmits the SRS in the set of symbols of the slot indicated as downlink symbols by an SFI-index field value in DCI format 2_0.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: a UE detects an SFI-index field value in DCI format 2_0 indicating the set of symbols of the slot as downlink and also detect a DCI format, a RAR UL grant, fallbackRAR UL grant, or successRAR indicating to the UE to transmit SRS, PUSCH, PUCCH, or PRACH, in one or more symbols from the set of symbols of the slot.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: a UE detects an SFI-index field value in DCI format 2_0 indicating the set of symbols of the slot as downlink or flexible if the set of symbols of the slot includes symbols corresponding to any repetition of a PUSCH transmission activated by an UL Type 2 grant PDCCH.
For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255: a UE detects an SFI-index field value in DCI format 2_0 indicating the set of symbols of the slot as uplink and also detect a DCI format indicating to the UE to receive PDSCH or CSI-RS in one or more symbols from the set of symbols of the slot.
If a UE is configured by higher layers to receive a CSI-RS or a PDSCH in a set of symbols of a slot and the UE detects a DCI format 2_0 with a slot format value other than 255 that indicates a slot format with a subset of symbols from the set of symbols as uplink or flexible, or the UE detects a DCI format indicating to the UE to transmit PUSCH, PUCCH, SRS, or PRACH in at least one symbol in the set of the symbols, the UE performs the CSI-RS reception in the set of symbols of the slot or performs the PDSCH reception in the slot.
If a UE is configured by higher layers to receive a DL PRS in a set of symbols of a slot and the UE detects a DCI format 2_0 with a slot format value other than 255 that indicates a slot format with a subset of symbols from the set of symbols as uplink, or the UE detects a DCI format indicating to the UE to transmit PUSCH, PUCCH, SRS, or PRACH in at least one symbol in the set of the symbols, the UE performs the DL PRS reception in the set of symbols of the slot.
If a UE is configured by higher layers to transmit SRS, or PUCCH, or PUSCH, or PRACH in a set of symbols of a slot and the UE detects a DCI format 2_0 with a slot format value other than 255 that indicates a slot format with a subset of symbols from the set of symbols as downlink or flexible, or the UE detects a DCI format indicating to the UE to receive CSI-RS or PDSCH in a subset of symbols from the set of symbols, then: If the UE does not indicate the capability of [partialCancellation], the UE performs the transmission of the PUCCH or PUSCH or PRACH in the set of symbols.
If a UE is configured by higher layers to transmit SRS, or PUCCH, or PUSCH, or PRACH in a set of symbols of a slot and the UE detects a DCI format 2_0 with a slot format value other than 255 that indicates a slot format with a subset of symbols from the set of symbols as downlink or flexible, or the UE detects a DCI format indicating to the UE to receive CSI-RS or PDSCH in a subset of symbols from the set of symbols, then: If the UE indicates the capability of [partialCancellation], the UE performs transmission of the PUCCH or PUSCH or PRACH in the set of symbols.
If a UE is configured by higher layers to transmit SRS, or PUCCH, or PUSCH, or PRACH in a set of symbols of a slot and the UE detects a DCI format 2_0 with a slot format value other than 255 that indicates a slot format with a subset of symbols from the set of symbols as downlink or flexible, or the UE detects a DCI format indicating to the UE to receive CSI-RS or PDSCH in a subset of symbols from the set of symbols, then: The UE perform the transmission of SRS in the subset of symbols.
A UE assumes that flexible symbols in a CORESET configured to the UE for PDCCH monitoring are downlink symbols if the UE detects an SFI-index field value in DCI format 2_0 indicating the set of symbols of the slot as flexible or uplink and the UE does not detect a DCI format indicating to the UE to transmit SRS, PUSCH, PUCCH, or PRACH in the set of symbols.
For a set of symbols of a slot that are indicated as uplink by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot: the UE receives PDSCH or CSI-RS in the set of symbols of the slot if the UE receives a corresponding indication by a DCI format.
For a set of symbols of a slot that are indicated as downlink by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot: the UE transmits PUSCH, PUCCH, PRACH, or SRS in the set of symbols of the slot if the UE receives a corresponding indication by a DCI format, a RAR UL grant, fallbackRAR UL grant, or successRAR.
For a set of symbols of a slot that are indicated as uplink by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot: the UE receives PDCCH as described in clause 10.1.
For a set of symbols of a slot that are indicated as flexible by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot: if the UE is configured by higher layers to receive PDSCH in the set of symbols of the slot, the UE receives the PDSCH in the set of symbols of the slot.
For a set of symbols of a slot that are indicated as uplink by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot: if the UE is configured by higher layers to receive PDSCH in the set of symbols of the slot, the UE receives the PDSCH in the set of symbols of the slot.
For a set of symbols of a slot that are indicated as uplink by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot: if the UE is configured by higher layers to receive DL PRS in the set of symbols of the slot, the UE receives the DL PRS.
For a set of symbols of a slot that are indicated as flexible by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot: if the UE is configured by higher layers to transmit SRS, or PUCCH, or PUSCH, or PRACH in the set of symbols of the slot and the UE is not provided enableConfiguredUL, then: the UE performs the transmission of SRS in the set of symbols.
For a set of symbols of a slot that are indicated as uplink by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot: if the UE is configured by higher layers to transmit SRS, or PUCCH, or PUSCH, or PRACH in the set of symbols of the slot and the UE is not provided enableConfiguredUL, then: the UE performs the transmission of SRS in the set of symbols.
For a set of symbols of a slot that are indicated as downlink by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot: if the UE is configured by higher layers to transmit SRS, or PUCCH, or PUSCH, or PRACH in the set of symbols of the slot and the UE is provided enableConfiguredUL, the UE can transmit the SRS, or PUCCH, or PUSCH, or PRACH, respectively.

A UE performs one or more actions/behaviors within a collision handling rule (or a first/old collision handling rule) listed above and performs one or more actions/behaviors within an exception/exemption of a collision handling rule (or a new/second collision handling rule) as listed above.

Collision handling rule(s) could be associated with beam(s) and/or frequency resource(s). In one example, a first collision handling rule(s) is associated with a first beam and/or a first set of beams. A second collision handling rule(s) is associated with a second beam and/or a second set of beams. The UE performs corresponding action for reception/transmission associated with a first beam and/or a first set of beams based on the first collision handling rule(s). The UE performs corresponding action for reception/transmission associated with a second beam and/or a second set of beams based on the second collision handling rule(s). For example, a UE is indicated a first collision handling rule(s) for a first beam and/or a first set of beams for a symbol and is indicated a second collision handling rule(s) for a second beam and/or a second set of beams for the symbol. The UE would perform a first collision handling rule(s) on the symbol or consider a scheduled UL transmission on the symbol an error case if/when configured UL transmission or scheduled UL transmission is associated with a first beam and/or a first set of beams. The UE would perform a second collision handling rule(s) on the symbol if/when configured UL transmission or scheduled UL transmission is associated with a second beam and/or a second set of beams.

In another example, a first collision handling rule(s) is associated with a first beam and/or a first set of beams. The first collision handling rule(s) is not associated with a second beam and/or a second set of beams. The UE performs corresponding action for reception/transmission the first beam and/or the first set of beams based on the first collision handling rule(s). The UE does not perform corresponding action for reception/transmission associated with a second beam and/or a second set of beams based on the first collision handling rule(s). For example, a UE is indicated a collision handling rule(s) applied for a first beam and/or a first set of beams for a symbol. The UE is indicated a collision handling rule(s) is not applied for a second beam and/or a second set of beams for the symbol. The UE would apply collision handling rule(s) for configured UL transmission or scheduled UL transmission if/when configured UL transmission or scheduled UL transmission is associated with a first beam and/or a first set of beams. The UE does not apply collision handling rule(s) for configured UL transmission or scheduled UL transmission if/when configured UL transmission or scheduled UL transmission is associated with a second beam and/or a second set of beams. The UE would perform a second collision handling rule(s) for configured UL transmission or scheduled UL transmission if/when configured UL transmission or scheduled UL transmission is associated with a second beam and/or a second set of beams.

Collision handling rules could be associated with frequency resources. In one example, a first collision handling rule(s) is associated with a first frequency resource(s). A second collision handling rule(s) is associated with a second frequency resource(s). The UE performs corresponding action for reception/transmission within the first frequency resource(s) based on the first collision handling rule(s). The UE performs corresponding action for reception/transmission within the second frequency resource(s) based on the second collision handling rule(s). For example, a UE is indicated a first collision handling rule(s) for a first frequency resource(s) for a symbol and is indicated a second collision handling rule(s) for a second resource(s) for the symbol. The UE would perform a first collision handling rule(s) on the symbol or consider a scheduled UL transmission on the symbol an error case if/when frequency resource of configured UL transmission or scheduled UL transmission is within the first frequency resource(s). The UE would perform a second collision handling rule(s) on the symbol if/when frequency resource of configured UL transmission or scheduled UL transmission is within the second frequency resource(s). In another example, a first collision handling rule(s) direction is associated with a first frequency resource(s). The first collision handling rule(s) is not associated with a second frequency resource(s). The UE performs corresponding action for reception/transmission within the first frequency resource(s) based on the first collision handling rule(s). The UE does not perform corresponding action for reception/transmission within the second frequency resource(s) based on the first collision handling rule(s). For example, a UE is indicated a collision handling rule(s) applied for a first frequency resource(s) for a symbol. The UE is indicated a collision handling rule(s) is not applied for a second frequency resource(s) for the symbol. The UE would apply collision handling rule(s) if/when frequency resource of configured UL transmission or scheduled UL transmission is within the first frequency resource(s). The UE does not apply collision handling rule(s) if/when frequency resource of configured UL transmission or scheduled UL transmission is within the second frequency resource(s). The UE would perform a second collision handling rule(s) if/when frequency resource of configured UL transmission or scheduled UL transmission is within the second frequency resource(s).

Transmission direction(s) on a symbol(s) could be associated with frequency resource(s). In one example, a first transmission direction is associated with a first frequency resource(s). A second transmission direction is associated with a second frequency resource(s). The UE performs corresponding action for reception/transmission within the first frequency resource(s) based on the first transmission direction. The UE performs corresponding action for reception/transmission within the second frequency resource(s) based on the second transmission direction. For example, a UE is indicated DL for a first frequency resource(s) for a symbol and is indicated UL for a second resource(s) for the symbol. The UE would cancel a configured UL transmission on the symbol or consider a scheduled UL transmission on the symbol an error case if/when frequency resource of configured UL transmission or scheduled UL transmission is within the first frequency resource(s). The UE would perform a configured UL transmission or a scheduled UL transmission on the symbol if/when frequency resource of configured UL transmission or scheduled UL transmission is within the second frequency resource(s). In another example, a first transmission direction is associated with a first frequency resource(s). The first transmission direction is not associated with a second frequency resource(s). The UE performs corresponding action for reception/transmission within the first frequency resource(s) based on the first transmission direction. The UE does not perform corresponding action for reception/transmission within the second frequency resource(s) based on the first transmission direction. For example, a UE is indicated DL for a first frequency resource(s) for a symbol. The UE is indicated DL is not applied for a second frequency resource(s) for the symbol. The UE would cancel a configured UL transmission on the symbol or consider a scheduled UL transmission on the symbol an error case if/when frequency resource of configured UL transmission or scheduled UL transmission is within the first frequency resource(s). The UE behaves as if DL is not indicated for the symbol for a configured UL transmission or a scheduled UL transmission if/when frequency resource of configured UL transmission or scheduled UL transmission is within the second frequency resource(s). The UE would perform a configured UL transmission or a scheduled UL transmission on the symbol if/when frequency resource of configured UL transmission or scheduled UL transmission is within the second frequency resource(s).

Association between collision handling rules and beams could be fixed or predefined. Association between collision handling rules and beams could be indicated from a base station to a UE. The association could be configured via RRC signaling and/or indicated via MAC CE. The association could be indicated via DCI. The DCI could be monitored periodically. The DCI indicates the association for a certain time period. The DCI updates the association when the association is changed. The association could be indicated together with SFI. The association could be indicated separately from SFI. For example, a first SFI-RNTI and/or a first location of SFI field could be associated with a first beam and/or a first set of beams. A second SFI-RNTI and/or a second location of SFI field could be associated with a second beam and/or a second set of beams. SFI indicated by DCI associated with the first SFI-RNTI and/or the first location of SFI field could be associated with the first beam and/or a first set of beams. SFI indicated by DCI associated with the second SFI-RNTI and/or the second location of SFI field could be associated with the second beam and/or the second set of beams. A bitmap associated with a SFI could be used to beam associated with the SFI.

In one embodiment, a UE applies a first collision handling rule(s). The UE applies a second collision handling rule(s). The UE determines whether to apply the first collision handling rule(s) or to apply the second collision handling rule(s) for reception/transmission based on a beam(s) associated with the reception/transmission. The rule(s) applies to all time/frequency resources (e.g., all following resource(s) upon indicated). The rule(s) applies to a subset of time resources (e.g., certain symbol(s) or slot(s)). The rule(s) applies to a subset of time resources (e.g., certain PRB(s)/BWP(s)). The rule(s) could be a rule(s) to enable duplexing enhancement. A UE applies a first collision handling rule(s) for a first beam and/or a first set of beams. The UE applies a second collision handling rule(s) for a second set of beams. The UE determines whether to apply the first collision handling rule(s) or to apply the second collision handling rule(s) for reception/transmission based on a beam(s) associated with the reception/transmission. A UE applies a first collision handling rule(s) for first transmission/reception associated with the first beam and/or first set of beams. The UE applies a second collision handling rule(s) for a second transmission/reception associated with the second beam and/or the second set of beams. The UE applies the first collision handling rule(s) for a (first) SFI if the (first) SFI is a first type of SFI. The UE applies the second collision handling rule(s) for a (second) SFI if the (second) SFI is a second type of SFI. A type of SFI could comprise one or more of the following: SFI indicted by RRC signal, SFI indicted by common RRC signal, SFI indicted by dedicated RRC signal, SFI indicted by DCI, SFI indicted by DCI format 2_0, SFI indicated by DCI scheduling a transmission/reception, SFI indicated by RRC configuring a transmission/reception. A UE applies a first collision handling rule(s) for a first type of transmission/reception. The UE applies a second collision handling rule(s) for a second type of transmission/reception. The UE determines whether to apply the first collision handling rule(s) or to apply the second collision handling rule(s) for a transmission/reception based on a type of transmission/reception. The UE determines whether to apply the first collision handling rule(s) or to apply the second collision handling rule(s) based on a type of transmission/reception. The UE applies the first collision handling rule(s) for a (first) transmission/reception if the (first) transmission/reception is a first type of transmission/reception. The UE applies the second collision handling rule(s) for a (second) transmission/reception if the (second) transmission/reception is a second type of transmission/reception. A type of transmission/reception could be one of the following: a DL reception, a UL transmission, a configured DL reception, a DL reception scheduled by DCI, a configured UL transmission, a UL transmission scheduled by DCI.

In another embodiment, a base station applies a first collision handling rule(s) for a UE. The base station applies a second collision handling rule(s) for the UE. The base station determines whether to apply the first collision handling rule(s) or to apply the second collision handling rule(s) for reception/transmission based on beam(s) associated with the reception/transmission. The rule(s) applies to all time/frequency resources (e.g., all following resource(s) upon indicated). The rule(s) applies to a subset of time resources (e.g., certain symbol(s) or slot(s)). The rule(s) applies to a subset of time resources (e.g., certain PRB(s)/BWP(s)). The rule(s) could be a rule(s) to enable duplexing enhancement. A base station applies a first collision handling rule(s) for the first beam and/or first set of beams for the UE. The base station applies a second collision handling rule(s) for the second beam and/or the second set of beams for the UE. A base station applies a first collision handling rule(s) for first transmission/reception associated with the first beam and/or first set of beams. The base station applies a second collision handling rule(s) for a second transmission/reception associated with the second beam and/or the second set of beams. The base station determines whether to apply the first collision handling rule(s) or to apply the second collision handling rule(s) for transmission/reception-based beam associated with the transmission/reception. A base station applies a first collision handling rule(s) for a first type of SFI for the UE. The base station applies a second collision handling rule(s) for a second type of SFI for the UE. The base station determines whether to apply the first collision handling rule(s) or to apply the second collision handling rule(s) based on a type of SFI. The base station applies the first collision handling rule(s) for a (first) SFI if the (first) SFI is a first type of SFI. The base station applies the second collision handling rule(s) for a (second) SFI if the (second) SFI is a second type of SFI. A type of SFI could comprise one or more of the following: SFI indicted by RRC signal, SFI indicted by common RRC signal, SFI indicted by dedicated RRC signal, SFI indicted by DCI, SFI indicted by DCI format 2_0, SFI indicated by DCI scheduling a transmission/reception, SFI indicated by RRC configuring a transmission/reception. A base station applies a first collision handling rule(s) for a first type of transmission/reception for a UE. The base station applies a second collision handling rule(s) for a second type of transmission/reception for a UE. The base station determines whether to apply the first collision handling rule(s) or to apply the second collision handling rule(s) for a transmission/reception based on a type of transmission/reception. The base station determines whether to apply the first collision handling rule(s) or to apply the second collision handling rule(s) based on a type of transmission/reception. The base station applies the first collision handling rule(s) for a (first) transmission/reception if the transmission/reception is a first type of transmission/reception. The base station applies the second collision handling rule(s) for a (second) transmission/reception if the transmission/reception is a second type of transmission/reception. A type of transmission/reception could be one of the following: a UL reception, a DL transmission, a configured UL reception, a UL reception scheduled by DCI, a configured DL transmission, a DL transmission scheduled by DCI.

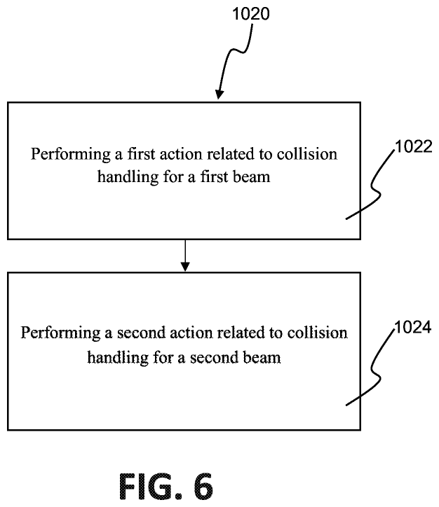

Referring to FIG. 6, with this and other concepts, systems, and methods of the present invention, a method 1020 for a UE in a wireless communication system comprises performing a first action related to collision handling for a first beam (step 1022), and performing a second action related to collision handling for a second beam (step 1024).

In various embodiments, the UE determines whether to perform the first action or the second action for a transmission/reception based on beam associated with the transmission reception.

In various embodiments, the first action and/or the second action applies to all time/frequency resources.

In various embodiments, the first action and/or the second action applies to a subset of time resources.

In various embodiments, the first action and/or the second action applies to a subset of time resources.

In various embodiments, the first action and/or the second action is an action to enable duplexing enhancement.

In various embodiments, the UE applies the first collision handling rule(s) for a first transmission/reception associated with the first beam.

In various embodiments, the UE applies the second collision handling rule(s) for a second transmission/reception associated with the second beam.

In various embodiments, the UE determines whether to apply the first collision handling rule(s) or to apply the second collision handling rule(s) to a transmission/reception based on a beam associated with the transmission/reception.

In various embodiments, the UE applies the first collision handling rule(s) for a first transmission/reception if the first transmission/reception is associated with the first beam.

In various embodiments, the UE applies the second collision handling rule(s) for a second transmission/reception if the second transmission/reception is associated with the second beam.

In various embodiments, the UE applies the first collision handling rule(s) for a first type of transmission/reception.

In various embodiments, the UE applies a second collision handling rule(s) for a second type of transmission/reception.

In various embodiments, the UE determines whether to apply the first collision handling rule(s) or to apply the second collision handling rule(s) for a transmission/reception based on a type of transmission/reception.

In various embodiments, the UE applies the first collision handling rule(s) for a first transmission/reception if the first transmission/reception is a first type of transmission/reception.

In various embodiments, the UE applies the second collision handling rule(s) for a second transmission/reception if the second transmission/reception is a second type of transmission/reception.

In various embodiments, the first type of transmission/reception and/or the second type of transmission/reception and/or the type of transmission/reception is one or more of the following: a DL reception, a UL transmission, a configured DL reception, a DL reception scheduled by DCI, a configured UL transmission, a UL transmission scheduled by DCI.

Referring back to FIGS. 3 and 4, in one or more embodiments from the perspective of a UE, the device 300 includes a program code 312 stored in memory 310 of the transmitter. The CPU 308 could execute program code 312 to: (i) perform a first action related to collision handling for a first beam; and (ii) perform a second action related to collision handling for a second beam. Moreover, the CPU 308 can execute the program code 312 to perform all of the described actions, steps, and methods described above, below, or otherwise herein.

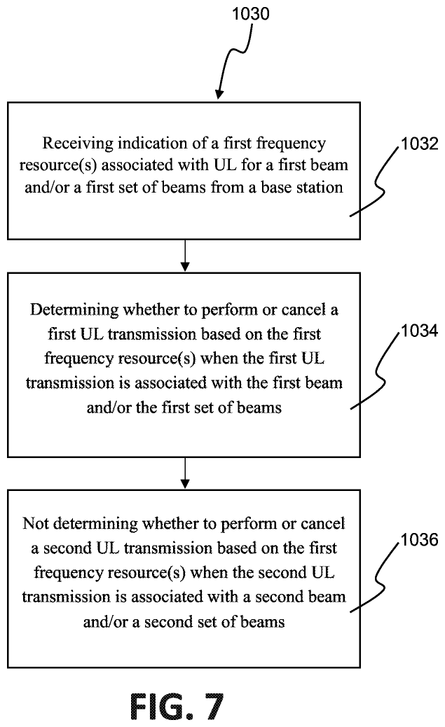

Referring to FIG. 7, with this and other concepts, systems, and methods of the present invention, a method 1030 for a UE in a wireless communication system comprises receiving indication of a first frequency resource(s) associated with UL for a first beam and/or a first set of beams from a base station (step 1032), determining whether to perform or cancel a first UL transmission based on the first frequency resource(s) when the first UL transmission is associated with the first beam and/or the first set of beams (step 1034), and not determining whether to perform or cancel a second UL transmission based on the first frequency resource(s) when the second UL transmission is associated with a second beam and/or a second set of beams (step 1036).

In various embodiments, the UE performs the first UL transmission if/when the first UL transmission is within the first frequency resource(s).

In various embodiments, the UE cancels the first UL transmission if/when the first UL transmission is outside the first frequency resource(s).

In various embodiments, the first frequency resource is not associated with the second beam and/or the second set of beams.

In various embodiments, the UE determines whether to perform or cancel the second UL transmission based on a slot format corresponding to both resources within the first frequency resource(s) and outside the first frequency resource(s).

In various embodiments, the UE determines whether to perform or cancel the first UL transmission based on the first frequency resource(s) due to the first UL transmission being associated with the first beam and/or the first set of beams.

Referring back to FIGS. 3 and 4, in one or more embodiments from the perspective of a UE, the device 300 includes a program code 312 stored in memory 310 of the transmitter. The CPU 308 could execute program code 312 to: (i) receive indication of a first frequency resource(s) associated with UL for a first beam and/or a first set of beams from a base station; (ii) determine whether to perform or cancel a first UL transmission based on the first frequency resource(s) when the first UL transmission is associated with the first beam and/or the first set of beams; and (iii) not determine whether to perform or cancel a second UL transmission based on the first frequency resource(s) when the second UL transmission is associated with a second beam and/or a second set of beams. Moreover, the CPU 308 can execute the program code 312 to perform all of the described actions, steps, and methods described above, below, or otherwise herein.

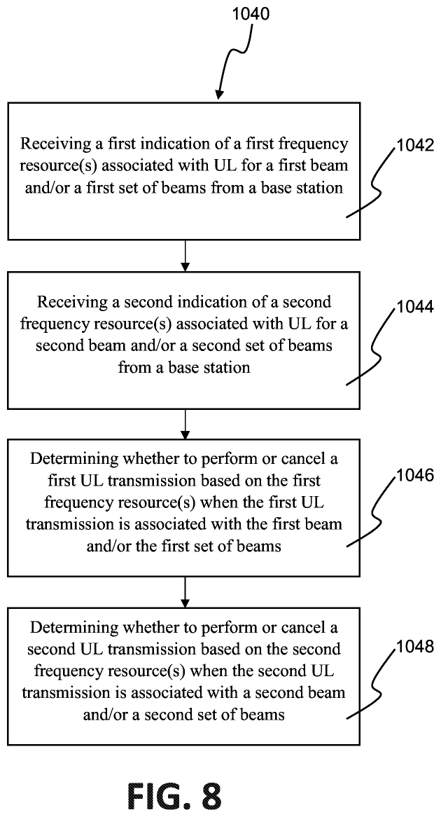

Referring to FIG. 8, with this and other concepts, systems, and methods of the present invention, a method 1040 for a UE in a wireless communication system comprises receiving a first indication of a first frequency resource(s) associated with UL for a first beam and/or a first set of beams from a base station (step 1042), receiving a second indication of a second frequency resource(s) associated with UL for a second beam and/or a second set of beams from a base station (step 1044), determining whether to perform or cancel a first UL transmission based on the first frequency resource(s) when the first UL transmission is associated with the first beam and/or the first set of beams (step 1046), and determining whether to perform or cancel a second UL transmission based on the second frequency resource(s) when the second UL transmission is associated with the second beam and/or the second set of beams (step 1048).

In various embodiments, the UE performs the first UL transmission if/when the first UL transmission is within the first frequency resource(s).

In various embodiments, the UE cancels the first UL transmission if/when the first UL transmission is outside the first frequency resource(s).

In various embodiments, the UE determines whether to perform or cancel the first UL transmission based on the first frequency resource(s) due to the first UL transmission being associated with the first beam and/or the first set of beams.

In various embodiments, the UE performs the second UL transmission if/when the first UL transmission is within the second frequency resource(s).

In various embodiments, the UE cancels the second UL transmission if/when the first UL transmission is outside the second frequency resource(s).

In various embodiments, the UE determines whether to perform or cancel the second UL transmission based on the second frequency resource(s) due to the second UL transmission being associated with the second beam and/or the second set of beams.

Referring back to FIGS. 3 and 4, in one or more embodiments from the perspective of a UE, the device 300 includes a program code 312 stored in memory 310 of the transmitter. The CPU 308 could execute program code 312 to: (i) receive a first indication of a first frequency resource(s) associated with UL for a first beam and/or a first set of beams from a base station; (ii) receive a second indication of a second frequency resource(s) associated with UL for a second beam and/or a second set of beams from a base station; (iii) determine whether to perform or cancel a first UL transmission based on the first frequency resource(s) when the first UL transmission is associated with the first beam and/or the first set of beams; and (iv) determine whether to perform or cancel a second UL transmission based on the second frequency resource(s) when the second UL transmission is associated with the second beam and/or the second set of beams. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE), comprising:
receiving indication of one or more first frequency resources associated with Uplink (UL) for a first beam and/or a first set of beams from a base station;
determining whether to perform or cancel a first UL transmission based on the one or more first frequency resources when the first UL transmission is associated with the first beam and/or the first set of beams; and
not determining whether to perform or cancel a second UL transmission based on the one or more first frequency resources when the second UL transmission is associated with a second beam and/or a second set of beams.

2. The method of claim 1, wherein the UE performs the first UL transmission when the first UL transmission is within the one or more first frequency resources.

3. The method of claim 1, wherein the UE cancels the first UL transmission when the first UL transmission is outside the one or more first frequency resources.

4. The method of claim 1, wherein the one or more first frequency resources are not associated with the second beam and/or the second set of beams.

5. The method of claim 1, wherein the UE determines whether to perform or cancel the second UL transmission based on a slot format corresponding to resources within the one or more first frequency resources and outside the one or more first frequency resources.

6. The method of claim 1, wherein the UE determines whether to perform or cancel the first UL transmission based on the one or more first frequency resources due to the first UL transmission being associated with the first beam and/or the first set of beams.

7. A method for a User Equipment (UE), comprising:
receiving a first indication of one or more first frequency resources associated with Uplink (UL) for a first beam and/or a first set of beams from a base station;
receiving a second indication of one or more second frequency resources associated with UL for a second beam and/or a second set of beams from a base station;
determining whether to perform or cancel a first UL transmission based on the one or more first frequency resources when the first UL transmission is associated with the first beam and/or the first set of beams; and
determining whether to perform or cancel a second UL transmission based on the one or more second frequency resources when the second UL transmission is associated with a second beam and/or a second set of beams.

8. The method of claim 7, wherein the UE performs the first UL transmission when the first UL transmission is within the one or more first frequency resources.

9. The method of claim 7, wherein the UE cancels the first UL transmission when the first UL transmission is outside the one or more first frequency resources.

10. The method of claim 7, wherein the UE determines whether to perform or cancel the first UL transmission based on the one or more first frequency resources due to the first UL transmission being associated with the first beam and/or the first set of beams.

11. The method of claim 7, wherein the UE performs the second UL transmission when the first UL transmission is within the one or more second frequency resources.

12. The method of claim 7, wherein the UE cancels the second UL transmission when the first UL transmission is outside the one or more second frequency resources.

13. The method of claim 7, wherein the UE determines whether to perform or cancel the second UL transmission based on the one or more second frequency resources due to the second UL transmission being associated with the second beam and/or the second set of beams.

14. A User Equipment (UE), comprising:
a memory; and
a processor operatively coupled to the memory, wherein the processor is configured to execute program code to:
receive indication of one or more first frequency resources associated with Uplink (UL) for a first beam and/or a first set of beams from a base station;
determine whether to perform or cancel a first UL transmission based on the one or more first frequency resources when the first UL transmission is associated with the first beam and/or the first set of beams; and
not determine whether to perform or cancel a second UL transmission based on the one or more first frequency resources when the second UL transmission is associated with a second beam and/or a second set of beams.

15. The UE of claim 14, wherein the UE performs the first UL transmission when the first UL transmission is within the one or more first frequency resources.

16. The UE of claim 14, wherein the UE cancels the first UL transmission when the first UL transmission is outside the one or more first frequency resources.

17. The UE of claim 14, wherein the one or more first frequency resources are not associated with the second beam and/or the second set of beams.

18. The UE of claim 14, wherein the UE determines whether to perform or cancel the second UL transmission based on a slot format corresponding to resources within the one or more first frequency resources and outside the one or more first frequency resources.

19. The UE of claim 14, wherein the UE determines whether to perform or cancel the first UL transmission based on the one or more first frequency resources due to the first UL transmission being associated with the first beam and/or the first set of beams.
